(19) United States
(12) Patent Application Publication
(10) Pub. No.: US 2024/0072919 A1
(43) Pub. Date: Feb. 29, 2024

(54) COMMUNICATION APPARATUS AND CONTROL METHOD THEREFOR

(71) Applicant: CANON KABUSHIKI KAISHA, Tokyo (JP)

(72) Inventor: SATORU TSUBOI, Kanagawa (JP)

(21) Appl. No.: 18/458,053

(22) Filed: Aug. 29, 2023

(30) Foreign Application Priority Data
Aug. 31, 2022 (JP) 2022-137745

(51) Int. Cl. H04J 3/06; H04L 69/22; H04N 23/661

(52) U.S. Cl. CPC H04J 3/0641; H04L 69/22; H04N 23/662

(57) ABSTRACT

A communication apparatus includes a reception unit configured to receive a predetermined packet from a time synchronization master terminal, a change unit configured to, in a case where the reception unit is not able to receive the predetermined packet within a predetermined time, change header information included in a predetermined packet transmitted by and received from a terminal newly becoming a time synchronization master to header information included in the predetermined packet received from the initial time synchronization master terminal, and a transmission unit configured to transmit the predetermined packet including the header information changed by the change unit to a second communication apparatus.

### BACKGROUND OF THE DISCLOSURE

### Field of the Disclosure

Aspects of the present disclosure generally relate to a synchronous control technique for synchronizing a plurality of apparatuses.

### Description of the Related Art

Techniques for performing synchronous image capturing with multiple viewpoints by a plurality of cameras installed at respective different positions and generating virtual viewpoint content using a multi-viewpoint image obtained by the synchronous image capturing are attracting attention. Such techniques enable users to view, for example, a highlight scene of soccer or basketball at various angles and are, therefore, able to give a high sense of presence to users as compared with an ordinarily captured image.

Japanese Patent Application Laid-Open No. 2017-211828 discusses a method of extracting pieces of image data in predetermined regions of images captured by a plurality of cameras and generating a virtual viewpoint image using the extracted pieces of image data. Image processing apparatuses are interconnected by a daisy chain and pieces of image data output from the respective image processing apparatuses are transmitted to an image generation apparatus by a daisy chain network. Moreover, Japanese Patent Application Laid-Open No. 2017-211828 also discusses a method of synchronizing image capturing timings of a plurality of cameras. Each control unit has the function of Precision Time Protocol (PTP) in the IEEE 1588 standards and implements synchronization by performing processing related to time synchronization (clock time synchronization) with a time server.

In a case where time synchronization is attempted by a synchronization slave terminal receiving time information supplied from a plurality of synchronization master terminals, the synchronization slave terminal selects most appropriate time information from among pieces of time information received from the plurality of synchronization master terminals to synchronize time information. As one of algorithms for selecting most appropriate time information, there is known Best Master Clock Algorithm (BMCA).

Since the synchronization accuracy between a synchronization slave terminal and a synchronization master terminal becomes lower as the synchronization slave terminal is more away from the synchronization master terminal, the synchronization slave terminal switches a time correction method depending on a synchronization error. When the synchronization error is larger than a threshold value, the synchronization slave terminal adjusts a time difference from the synchronization master terminal to time generated by the synchronization slave terminal itself, and calculates a clock frequency of the synchronization master terminal from information about synchronous packets which are used for time synchronization, thus adjusting a clock frequency of the synchronization slave terminal itself. On the other hand, when the synchronization error is smaller than the threshold value, the synchronization slave terminal performs only adjustment of clock frequencies.

When the synchronization master terminal and the synchronization slave terminal are performing time synchronization, an issue may occur in the synchronization master terminal and, thus, the synchronization slave terminal may become unable to acquire time information (synchronous packets) within a predetermined time. Terminals included in the synchronous network detect that an issue has occurred in the synchronization master terminal, and terminals which are capable of functioning as a synchronization master terminal transmit time information generated by the terminals themselves to each other, so that a new synchronization master terminal is determined within the synchronous network by, for example, BMCA. Then, the synchronization slave terminal uses time information generated by the new synchronization master terminal to perform time synchronization.

However, until time synchronization with the new synchronization master terminal is completed, the synchronization slave terminal continues keeping time at the adjusted clock frequency. Since a terminal located further away from the synchronization master terminal is larger in synchronization error, the amount of frequency adjustment which is performed for time correction is larger. Since, as the amount of frequency adjustment is larger, a deviation from the clock frequency of the synchronization master terminal is larger, as a time for which the the synchronization slave terminal continues keeping time at the clock frequency of the synchronization slave terminal itself becomes longer, a time error from the time generated by the synchronization master terminal increases.

### SUMMARY OF THE DISCLOSURE

Aspects of the present disclosure are generally directed to providing a slave terminal (communication apparatus) configured to be capable of performing appropriate synchronization even if a time synchronization master terminal has changed.

According to an aspect of the present disclosure, a communication apparatus includes a reception unit configured to receive a predetermined packet from a time synchronization master terminal, a change unit configured to, in a case where the reception unit is not able to receive the predetermined packet within a predetermined time, change header information included in a predetermined packet transmitted by and received from a terminal newly becoming a time synchronization master to header information included in the predetermined packet received from the initial time synchronization master terminal, and a transmission unit configured to transmit the predetermined packet including the header information changed by the change unit to a second communication apparatus.

Further features of the present disclosure will become apparent from the following description of exemplary embodiments with reference to the attached drawings.

### BRIEF DESCRIPTION OF THE DRAWINGS

FIG. 1 is a block diagram illustrating a configuration of a synchronous image capturing system according to a first exemplary embodiment.

FIG. 2 is a block diagram illustrating a configuration of a camera adapter.

FIG. 3 is a block diagram illustrating a configuration of a time server.

FIG. 4 is a diagram illustrating a synchronous image capturing sequence of the synchronous image capturing system.

FIG. 5 is a flowchart illustrating time synchronization processing which is performed by the time server.

FIG. 6 is a flowchart illustrating time synchronization processing which is performed by the time server.

FIG. 7 is a flowchart illustrating time synchronization processing which is performed by the time server.

FIGS. 8A and 8B are flowcharts illustrating time synchronization processing which is performed by the camera adapter in the first exemplary embodiment.

FIGS. 9A and 9B are flowcharts illustrating synchronous packet processing which is performed by the camera adapter in the first exemplary embodiment.

FIG. 10 is a flowchart illustrating the Best Master Clock Algorithm (BMCA).

FIG. 11 is a flowchart illustrating the BMCA.

FIG. 12 is a diagram illustrating a time synchronization sequence which is performed between the time server and two camera adapters.

FIGS. 13A and 13B are flowcharts illustrating time synchronization processing which is performed by the camera adapter in a second exemplary embodiment.

FIGS. 14A and 14B are flowcharts illustrating synchronous packet processing which is performed by the camera adapter in the second exemplary embodiment.

### DESCRIPTION OF THE EMBODIMENTS

Various exemplary embodiments, features, and aspects of the present disclosure will be described in detail below with reference to the drawings. Furthermore, the following exemplary embodiments are not intended to limit the present disclosure set forth in the claims. While a plurality of features is described in each exemplary embodiment, not all of the features are necessarily essential, and, moreover, some of the plurality of features can be optionally combined. In the accompanying drawings, the same or similar configurations are assigned the respective same reference numerals and any duplicated description thereof is omitted.

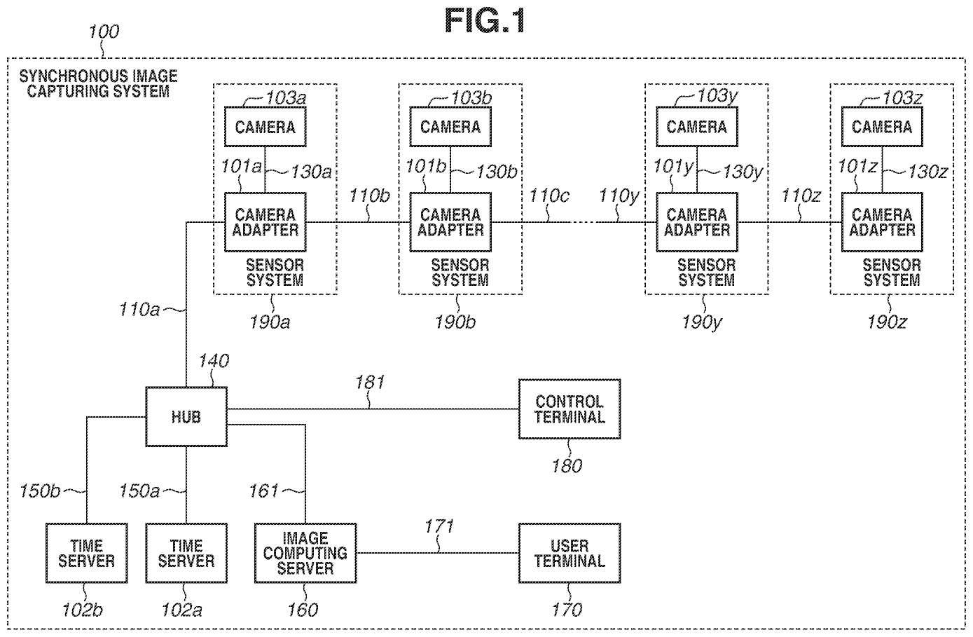

A synchronous image capturing system for performing image capturing with a plurality of cameras installed at a facility such as a sports arena (stadium) or a concert hall is described with reference to FIG. 1. The synchronous image capturing system 100 includes sensor systems 190a to 190z, an image computing server 160, a user terminal 170, a control terminal 180, a hub 140, and time servers 102a and 102b. The sensor systems 190a to 190z are provided as twenty-six sets in the synchronous image capturing system 100. The sensor systems 190a to 190z are connected by daisy chain communication paths 110b to 110z. The sensor system 190a and the hub 140 are connected by a communication path 110a. The image computing server 160 and the user terminal 170 are connected by a communication path 171. The sensor systems 190a to 190z include cameras 103a to 103z and camera adapters 101a to 101z, respectively. The user terminal 170 includes a display unit (not illustrated). The user terminal 170 is, for example, a personal computer, a tablet terminal, or a smartphone. Each of the time servers 102a and 102b is a terminal which is able to become a time synchronization master terminal in the synchronous image capturing system 100. For example, in a case where the time server 102a is an initial time synchronization master terminal, if the time server 102a ceases to function as a time synchronization master terminal, the time server 102b becomes a new time synchronization master terminal. The time servers 102a and 102b are assumed to be synchronized with the same time source (reference clock), such as the Global Positioning System (GPS). The synchronous image capturing system 100 can be referred to as a “time synchronization system”.

The control terminal 180 performs, for example, operating condition management and parameter setting control on the hub 140, the image computing server 160, and the time servers 102a and 102b, which constitute the synchronous image capturing system 100, via the communication paths (communication lines) 181, 161, 150a, and 150b. Each of the communication paths 181, 171, 161, 150a, and 150b is a network line (network cable) compliant with Ethernet. More specifically, each of the communication paths 181, 171, 161, 150a, and 150b can be Gigabit Ethernet (GbE) or 10 Gigabit Ethernet (10 GbE) compliant with the IEEE standard. Furthermore, each of the communication paths 181, 171, 161, 150a, and 150b can be configured by combining, for example, various interconnects such as Infiniband and industrial Ethernet. Moreover, such a communication path is not limited to these, but can be another type of network line.

First, an operation for transmitting a signal or image from the sensor system 190z to the image computing server 160 is described. In the synchronous image capturing system 100 in the first exemplary embodiment, the sensor systems 190a to 190z are connected by a daisy chain.

In the first exemplary embodiment, unless specifically described, each of the sensor systems 190a to 190z for twenty-six sets is referred to as a “sensor system 190” without being distinguished. Similarly with regard to devices included in each sensor system 190, unless specifically described, each of twenty-six cameras 103a to 103z is referred to as a “camera 103” without being distinguished, and each of the camera adapters 101a to 101z is referred to as a “camera adapter 101” without being distinguished.

Furthermore, while the number of sensor systems is set as twenty-six, this is merely an example, and the number of sensor systems is not limited to this. Moreover, the sensor systems 190a to 190z do not need to have the same configurations (can be configured with respective different model devices). Furthermore, in the first exemplary embodiment, unless otherwise described, the term “image” is assumed to include notions of a moving image and a still image. In other words, the synchronous image capturing system 100 in the first exemplary embodiment is assumed to be applicable to both a still image and a moving image.

The sensor systems 190a to 190z include respective single cameras 103a to 103z. Thus, the synchronous image capturing system 100 includes a plurality of (twenty-six) cameras 103 configured to capture the image of a subject from a plurality of directions. Furthermore, the plurality of cameras 103a to 103z are described with use of the same reference character “103”, but can be configured to differ from each other in performance or model.

Since the sensor systems 190a to 190z are daisy-chained, with respect to an increase of the volume of image data associated with the attainment of high resolution of captured images into, for example, 4K resolution or 8K resolution or the attainment of higher frame rate, it is possible to reduce the number of connection cables or achieve labor savings of wiring work.

Furthermore, the connection configuration of the sensor systems 190a to 190z is not limited to daisy chain. For example, a star network configuration, in which each of the sensor systems 190a to 190z is connected to the hub 140 and performs data transmission and reception between the sensor systems 190a to 190z via the hub 140, can be employed.

Moreover, while, in FIG. 1, a configuration in which all of the sensor systems 190a to 190z are daisy-chained is illustrated, the first exemplary embodiment is not limited to such a connection configuration. For example, a configuration in which a plurality of sensor systems 190 is divided into some groups and the sensor systems 190 are daisy chained for each of the divided groups can be employed. Such a configuration is particularly effective against stadiums. For example, a case where the stadium is configured with a plurality of floors and the sensor system 190 is installed for each floor is conceivable. In this case, it is possible to perform inputting to the image computing server 160 for each floor or for each semiperimeter of the stadium, so that, even in a location in which it is difficult to perform wiring for connecting all of the sensor systems 190 with one daisy chain, it is possible to attain the simplification of installation and the flexibility of each system.

The control for image processing by the image computing server 160 is switched depending on whether the number of camera adapters 101 which are daisy-chained and configured to perform image inputting to the image computing server 160 is one or two or more. Thus, the control is switched depending on whether the sensor systems 190 are divided into a plurality of groups. In a case where the number of camera adapters 101 configured to perform image inputting is one (camera adapter 101a), since an image for the entire perimeter of the stadium is generated while image transmission is being performed via the daisy chain connection, the timing at which image data for the entire perimeter becomes complete in the image computing server 160 is in synchronization. Thus, unless the sensor systems 190 are not divided into a plurality of groups, the timing is in synchronization.

However, in a case where the number of camera adapters 101 configured to perform image inputting is two or more (a case where the sensor systems 190a to 190z are divided into a plurality of groups), a case where a delay occurring after an image is captured until the captured image is input to the image computing server 160 differs with each lane (path) of the daisy chain is conceivable. Thus, in a case where the sensor systems 190 are divided into a plurality of groups, the timing at which image data for the entire perimeter of the stadium is input to the image computing server 160 may in some cases out of synchronization. Therefore, in the image computing server 160, it is necessary to perform image processing at a subsequent stage while checking amassment of image data by synchronous control for taking synchronization after waiting for image data for the entire perimeter to become complete.

In the first exemplary embodiment, the sensor system 190a includes a camera 103a and a camera adapter 101a. Furthermore, the configuration of the sensor system 190a is not limited to this. For example, the sensor system 190a can be configured to further include, for example, an audio device (such as a microphone) or a panhead for controlling the orientation of the camera 103a. Moreover, the sensor system 190a can be configured with one camera adapter 101a and a plurality of cameras 103a, or can be configured with one camera 103a and a plurality of camera adapters 101a. Thus, a plurality of cameras 103 and a plurality of camera adapters 101 included in the synchronous image capturing system 100 are associated with each other in a ratio of J to K (each of J and K being an integer greater than or equal to “1”). Moreover, the camera 103 and the camera adapter 101 can be configured to be integral with each other. Additionally, at least a part of the function of the camera adapter 101 can be included in the image computing server 160. In the first exemplary embodiment, the configurations of the sensor systems 190b to 190z are similar to that of the sensor system 190a, and are, therefore, omitted from description. Furthermore, the configurations of the sensor systems 190b to 190z are not limited to the same configuration as that of the sensor system 190a, and the sensor systems 190a to 190z can be configured to have respective different configurations.

An image captured by the camera 103z is subjected to image processing described below by the camera adapter 101z, and is then transmitted to the camera adapter 101y of the sensor system 190y via a daisy chain 110z. Similarly, the sensor system 190y transmits, to an adjacent sensor system 190x (not illustrated), an image captured by the camera 103y in addition to the image acquired from the sensor system 190z.

With such operations and processing being continued, the images acquired by the sensor systems 190a to 190z are transferred from the sensor system 190a to the hub 140 via the communication path 110a, and are then transmitted from the hub 140 to the image computing server 160. Furthermore, in the first exemplary embodiment, the cameras 103a to 103z and the camera adapters 101a to 101z are configured to be separate from each other, respectively, but can be configured to be integral with each other, respectively, by the respective same casings.

Next, operations of the image computing server 160 are described. The image computing server 160 in the first exemplary embodiment performs processing on data (image packet) acquired from the sensor system 190a. First, the image computing server 160 reconfigures the image packet acquired from the sensor system 190a to convert the data format thereof, and then stores the obtained data according the identifier of the camera, the data type, and the frame number. Then, the image computing server 160 receives the designation of a viewpoint from the control terminal 180, reads out image data corresponding to the information stored based on the received viewpoint, and performs rendering processing on the image data to generate a virtual viewpoint image. Furthermore, at least a part of the function of the image computing server 160 can be included in the control terminal 180, the sensor system 190, and/or the user terminal 170.

An image obtained by performing rendering processing is transmitted from the image computing server 160 to the user terminal 170 and is then displayed on the display unit of the user terminal 170. Accordingly, the user operating the user terminal 170 is enabled to view an image corresponding to the designated viewpoint. Thus, the image computing server 160 generates virtual viewpoint content that is based on images captured by a plurality of cameras 103a to 103z (multi-viewpoint image) and viewpoint information. Furthermore, while, in the first exemplary embodiment, virtual viewpoint content is assumed to be generated by the image computing server 160, the first exemplary embodiment is not limited to this. Thus, virtual viewpoint content can be generated by the control terminal 180 or the user terminal 170.

Each of the time servers 102a and 102b has the function of delivering time, and delivers time to the sensor system 190. Each sensor system 190 performs time synchronization with any one of the two time servers 102a and 102b. The details thereof are described below. In the sensor systems 190a to 190z, the camera adapters 101a to 101z having received time performs synchronization signal generator lock (genlock) on the cameras 103a to 103z based on the time information, thus performing image frame synchronization. Thus, the time server 102 synchronizes image capturing timings of a plurality of cameras 103. With this operation, the synchronous image capturing system 100 is able to generate a virtual viewpoint image based on a plurality of images captured at the same timing and is thus able to prevent or reduce a decrease in quality of a virtual viewpoint image caused by the deviation of image capturing timings. Furthermore, the two time servers 102a and 102b described in the present specification are assumed to be the same product and be configured with the same settings. This is employed to, in implementing time synchronization within the synchronous image capturing system 100 with use of a plurality of synchronization masters (time servers 102a and 102b) in one synchronous image capturing system (synchronous network) 100, make the capabilities of the synchronization masters consistent with each other.

The time servers 102a and 102b are a plurality of terminals each able to become a time synchronization master.

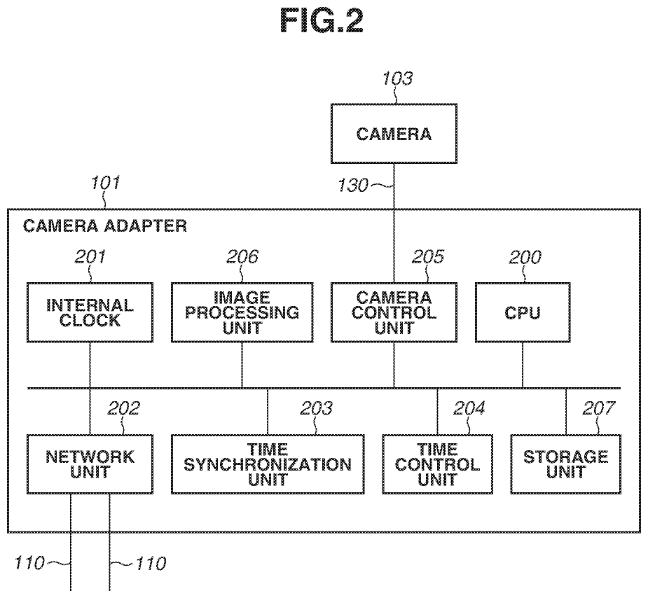

Next, a configuration of the camera adapter 101 is described with reference to FIG. 2.

The camera adapter 101 includes a central processing unit (CPU) 200, an internal clock 201, a network unit 202, a time synchronization unit 203, a time control unit 204, a camera control unit 205, an image processing unit 206, and a storage unit 207.

The CPU 200 is a processing unit which controls the entire camera adapter 101. A program which the CPU 200 executes is stored in the storage unit 207. Moreover, for example, a synchronous packet which the CPU 200 transmits and receives is also stored in the storage unit 207. The storage unit 207 includes, for example, a read-only memory (ROM) or a random access memory (RAM).

The internal clock 201 includes, for example, a hardware clock which retains current time. The internal clock 201 periodically outputs a reference signal serving as a time reference within the camera adapter 101 based on, for example, a hardware clock signal.

The network unit 202 is connected to an adjacent sensor system 190 or the hub 140 via the daisy chain 110. Moreover, the network unit 202 performs transmission and reception of data with the time servers 102a and 102b, the image computing server 160, and the control terminal 180 via the hub 140. The network unit 202 includes at least two communication ports to configure the daisy chain 110. The network unit 202 is, for example, a network interface card (NIC). Furthermore, the network unit 202 is not limited to this, but can be replaced with another element capable of transmitting and receiving data to and from another apparatus. The network unit 202 is compliant with, for example, the IEEE 1588 standard, and has the function of storing a time stamp obtained when the network unit 202 has transmitted or received data to or from the time server 102a or 102b. The network unit 202 has the function of, when having received a multicast packet or a packet the destination of which is other than the network unit 202 itself, transfer the received packet to a port different from the port used for reception. Furthermore, the network unit 202 can be configured to use the function of storing a time stamp even at the time of reception of a packet, at the time of transmission of a packet, or at the time of transfer of a packet, or can be configured to include a buffer such as first-in first-out (FIFO) memory in such a way as to be able to store time stamps for a plurality of packets. Moreover, the function of the internal clock 201 can be incorporated in the network unit 202.

Additionally, the network unit 202 finally transmits a foreground image and a background image, which have been separated by the image processing unit 206 from a captured image acquired from the camera 103, to the image computing server 160 via the camera adapter 101 and the hub 140. Each camera adapter 101 outputting the foreground image and the background image causes a virtual viewpoint image to be generated based on a foreground image and a background image captured from a plurality of viewpoints. Furthermore, a camera adapter 101 which outputs a foreground image separated from the captured image but does not output a background image can be included.

The time synchronization unit 203 generates a communication packet for performing time synchronization with a method compliant with, for example, the IEEE 1588-2008 standard. The generated communication packet is sent to the daisy chain 110 via the network unit 202, and is then finally transferred to the time server 102 via the network 150. With the communication performed with the time server 102, the time synchronization unit 203 synchronizes the internal clock 201 with time generated by the time server 102. Moreover, the time synchronization unit 203 transmits and receives data to and from the time server 102 to calculate a transmission delay occurring between the time server 102 and the camera adapter 101, thus being able to calculate an error (offset) from time generated by the time server 102. Additionally, the camera adapter 101 has the function of measuring a time for which a communication packet used for time synchronization stays in the camera adapter 101 itself and adding the measured time to a designated region of the communication packet to be transferred. Thus, the camera adapter 101 is assumed to operate as a transparent clock (hereinafter referred to as a “TC”) in the IEEE 1588-2008 standard. Furthermore, the hub 140 included in the synchronous image capturing system 100 in the first exemplary embodiment is also assumed to operate as a TC. As a result, it becomes possible to separate an error (transmission delay) of a communication packet into a time for which the communication packet passes through a network cable and a time for which the communication packet passes through the camera adapter 101, and thus becomes possible to perform time synchronization with a higher degree of accuracy. Furthermore, the time synchronization unit 203 is able to retain the calculated error and supply information about the calculated error to the time control unit 204 described below. Moreover, the time synchronization unit 203, in which a Best Master Clock Algorithm (BMCA) operates, also performs processing for determining a time server 102 with which the time synchronization unit 203 itself is to be synchronized. The details of these are described below. Moreover, the time synchronization unit 203 also retains a timer function, and the timer function is used for time synchronization processing to be performed with the time server 102.

The time control unit 204 adjusts the internal clock 201 based on time generated by the time server 102, which the time synchronization unit 203 has acquired, and an error in time between the time server 102 and the camera adapter 101. The time control unit 204 previously defines, for example, a threshold value with respect to an error from a time which the time server 102 retains. In a case where the error is larger than the threshold value, the time control unit 204 adds or subtracts a time difference from the time server 102 to or from the internal clock 201 for the time control unit 204 itself. Then, the time control unit 204 calculates a clock frequency of the time server 102 for synchronization from a time synchronization sequence described below, and applies the calculated clock frequency to a clock frequency of the internal clock 201 for the time control unit 204 itself (performs adjustment of a clock frequency). In a case where the error is smaller than the threshold value, the time control unit 204 performs only adjustment of a clock frequency.

The image processing unit 206 performs processing on image data captured by the camera 103 under the control of the camera control unit 205 and image data received from another camera adapter 101. The processing (function) which the image processing unit 206 performs is described below in detail.

The image processing unit 206 has the function of separating image data captured by the camera 103 into a foreground image and a background image. Thus, each of a plurality of camera adapters 101 operates as an image processing device which extracts a predetermined region from an image captured by a corresponding camera 103 out of a plurality of cameras 103. The predetermined region is, for example, a foreground image which is obtained as a result of object detection performed on the captured image, and, with this predetermined region extraction, the image processing unit 206 separates the captured image into a foreground image and a background image. Furthermore, the object is, for example, a person. However, the object can be a specific person (such as a player, a manager, and/or an umpire), or can be an object the image pattern of which is previously determined, such as a ball or goal. Moreover, the image processing unit 206 can be configured to detect a moving body as the object. The image processing unit 206 performs processing for separation into a foreground image, which includes an important object such as a person, and a background image, which does not include such an object, so that the quality of an image of a portion corresponding to the above-mentioned object of a virtual viewpoint image which is generated in the synchronous image capturing system 100 can be increased. Moreover, each of a plurality of camera adapters 101 performs separation into a foreground image and a background image, so that the load on the synchronous image capturing system 100, which includes a plurality of cameras 103, can be distributed. Furthermore, the predetermined region is not limited to a foreground image, but can be, for example, a background image.

The image processing unit 206 has the function of using the separated foreground image and a foreground image received from another camera adapter 101 to generate image information concerning a three-dimensional model using, for example, the principle of a stereophonic camera.

The image processing unit 206 has the function of acquiring image data required for calibration from the camera 103 via the camera control unit 205 and transmitting the acquired image data to the image computing server 160, which performs processing concerning calibration. The calibration in the first exemplary embodiment is processing for associating parameters concerning each of a plurality of cameras 103 with each other to perform matching therebetween. The calibration to be performed includes, for example, processing for performing adjustment in such a manner that world coordinate systems retained by the respective installed cameras 103 become consistent with each other and color correction processing for preventing or reducing any variation in color between cameras 103. Furthermore, the specific processing content of the calibration is not limited to this. Moreover, while, in the first exemplary embodiment, computation processing concerning the calibration is performed by the image computing server 160, a node which performs computation processing is not limited to the image computing server 160. For example, the computation processing can be performed by another node, such as the control terminal 180 or the camera adapter 101 (including another camera adapter 101). Moreover, the image processing unit 206 has the function of performing a calibration in the process of image capturing (dynamic calibration) according to previously set parameters with respect to image data acquired from the camera 103 via the camera control unit 205. Furthermore, for example, these foreground image and background image are finally transmitted to the image computing server 160.

The camera control unit 205 is connected to the camera 103, and has the function of performing, for example, control of the camera 103, acquisition of a captured image, provision of a synchronization signal, and time setting. The control of the camera 103 includes, for example, setting and reference of image capturing parameters (such as the number of pixels, color depth, frame rate, setting of white balance), acquisition of states of the camera 103 (such as image capturing in progress, stopping in progress, synchronization in progress, and error), starting and stopping of image capturing, and focus adjustment. Furthermore, while, in the first exemplary embodiment, focus adjustment is performed via the camera 103, in a case where a detachable lens is mounted on the camera 103, the camera adapter 101 can be configured to be connected to the lens and to directly perform adjustment of the lens.

Moreover, the camera adapter 101 can be configured to perform lens adjustment such as zoom via the camera 103. The provision of a synchronization signal is performed by using time at which the time synchronization unit 203 has become synchronized with the time server 102 or a reference signal to provide image capturing timing (control clock) to the camera 103. The time setting is performed by providing time at which the time synchronization unit 203 has become synchronized with the time server 102, with a time code compliant with, for example, the format of SMPTE12M. This causes the provided time code to be appended to image data received from the camera 103. Furthermore, the format of the time code is not limited to SMPTE12M, but can be another format.

Furthermore, some or all of the time synchronization unit 203, the time control unit 204, the camera control unit 205, and the image processing unit 206 illustrated in FIG. 2 can be mounted in the camera adapter 101 as software. Alternatively, they can be mounted in the camera adapter 101 as dedicated hardware such as an application specific integrated circuit (ASIC) or a programmable logic array (PLA). In a case where they are mounted as hardware, they can be mounted as a dedicated hardware module for each unit or for aggregation of some units.

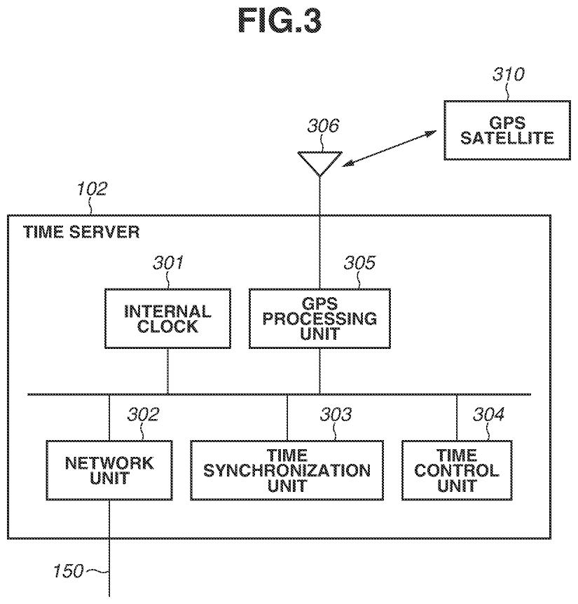

Next, functional blocks of the time server 102 are described with reference to FIG. 3.

The time server 102 includes an internal clock 301, a network unit 302, a time synchronization unit 303, a time control unit 304, and a Global Positioning System (GPS) processing unit 305. The GPS processing unit 305 has an antenna 306 fixed thereon.

The internal clock 301 is, for example, a hardware clock which retains current time.

The network unit 302 is connected to the camera adapter 101 via the hub 140, and performs transmission and reception of a communication packet for performing time synchronization with the camera adapter 101. Moreover, the network unit 302 is compliant with, for example, the IEEE 1588 standard, and has the function of storing a time stamp obtained when the network unit 302 has transmitted or received data to or from the camera adapter 101. Furthermore, the function of the internal clock 301 can be included in the network unit 302.

The time synchronization unit 303 generates a communication packet for performing time synchronization with a method compliant with, for example, the IEEE 1588-2008 standard. The generated communication packet is sent to the network 150 via the network unit 302, and is then transferred to the camera adapter 101 via the hub 140. Moreover, the time synchronization unit 303, in which a BMCA operates, also performs processing for determining whether the time synchronization unit 303 itself operates as a synchronization master. The details thereof are described below. Moreover, the time synchronization unit 303 also retains a timer function, and the timer function is used for time synchronization processing to be performed with the camera adapter 101.

The time control unit 304 adjusts the internal clock 301 based on time information acquired by the GPS processing unit 305. Thus, the time servers 102a and 102b included in the synchronous image capturing system 100 are able to be synchronized in time with a high degree of accuracy by receiving radio waves from a GPS satellite 310.

The GPS processing unit 305 acquires a signal from the GPS satellite 310 with use of the antenna 306, and receives time information transmitted from the GPS satellite 310.

Furthermore, while time synchronization between the time servers 102a and 102b is performed via the GPS satellite 310, the time synchronization does not need to depend on GPS. However, in light of the synchronization accuracy of the entire synchronous image capturing system 100, a method capable of making the synchronization accuracy between the time server 102a and the time server 102b higher than the synchronization accuracy between the camera adapter 101 and the time server 102 needs to be employed.

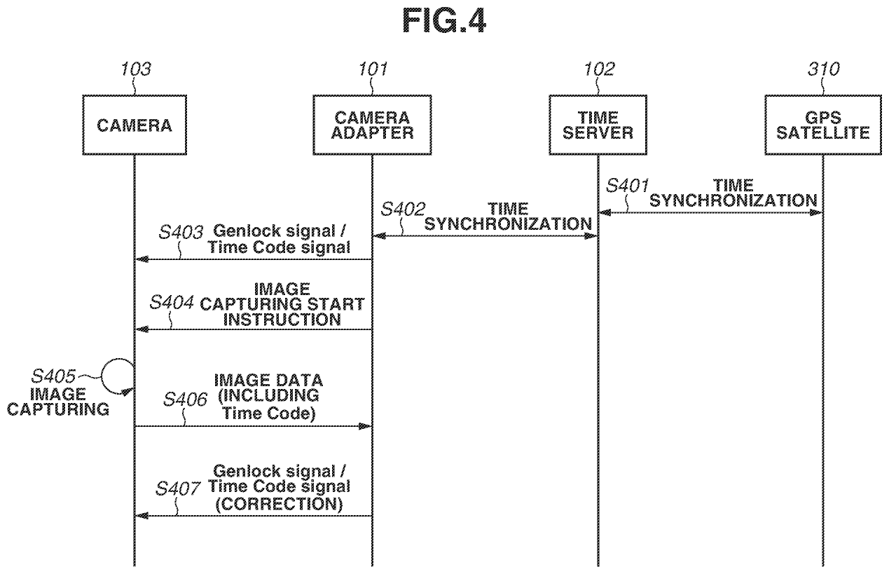

Next, an image capturing start processing sequence for the camera 103 is described with reference to FIG. 4.

In step S401, the time server 102 performs time synchronization with the GPS satellite 310, and performs setting of time which is managed within the time server 102. Next, in step S402, the camera adapter 101 performs a communication using Precision Time Protocol Version 2 (PTPv2) with the time server 102, corrects time which is managed within the camera adapter 101 (internal clock 201), and performs time synchronization with the time server 102. In step S403, the camera adapter 101 starts providing a genlock signal, a synchronous image capturing signal such as a three-valued synchronization signal, and a time code signal to the camera 103 in synchronization with the image capturing frame. Furthermore, information to be provided is not limited to a time code, but can be another piece of information as long as it is an identifier capable of identifying the image capturing frame. Next, in step S404, the camera adapter 101 transmits an image capturing start instruction to the camera 103.

Since all of the plurality of camera adapters 101 have become synchronized in time with the time server 102, start timings are able to be synchronized with each other. In step S405, upon receiving the image capturing start instruction, the camera 103 performs image capturing in synchronization with the genlock signal. Next, in step S406, the camera 103 causes a time code signal to be included in the captured image and transmits the captured image including the time code signal to the camera adapter 101. Until the camera 103 stops image capturing, image capturing synchronized with the genlock signal continues. In step S407, the camera adapter 101 performs PTP time correction processing with the time server 102 in the middle of image capturing to correct generation timing of the genlock signal. In a case where the required amount of correction becomes large (for example, a case where the required amount of correction becomes greater than or equal to a threshold value), the camera adapter 101 can be configured to apply correction corresponding to a previously set amount of change.

With the above-described processing, it is possible to implement synchronous image capturing of a plurality of cameras 103 which is connected to a plurality of camera adapters 101 included in the synchronous image capturing system 100. Furthermore, while, in FIG. 4, the image capturing start processing sequence of the camera 103 has been described, in a case where a microphone is provided in the sensor system 190, with respect to sound collection by the microphone, processing similar to that for synchronous image capturing of the camera 103 is also performed to enable performing synchronous sound collection.

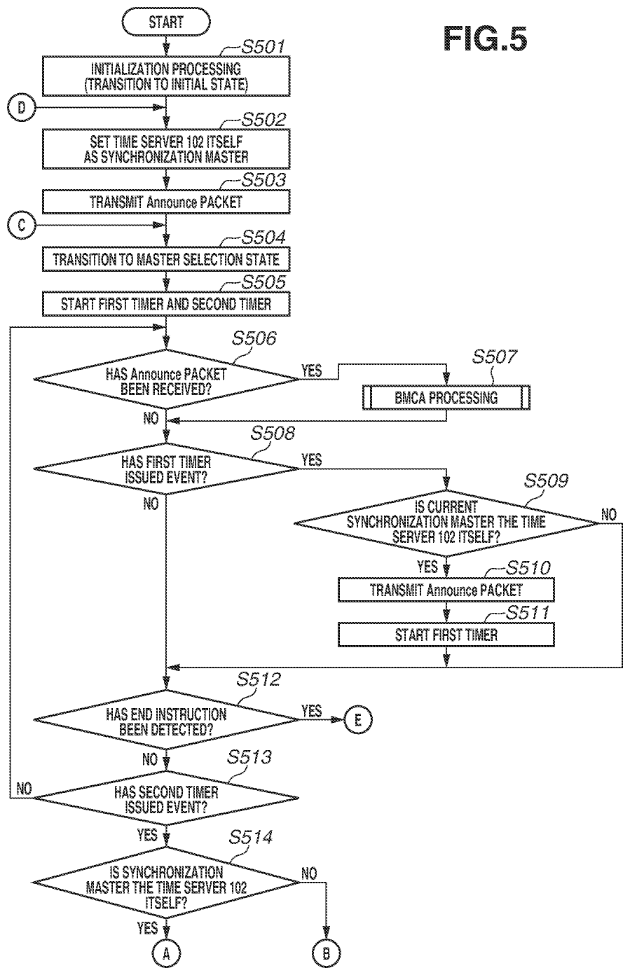

Next, a time synchronization processing flow of the time server 102 is described with reference to FIG. 5 to FIG. 7. The present flow starts in response to the time server 102 being powered on and a time synchronization process being started up. Moreover, after the present flow ends, in a case where the time synchronization process has been started up again, the present flow also starts.

In step S501, the time server 102 performs initialization processing for implementing time synchronization of the synchronous image capturing system 100. The initialization processing includes, for example, time synchronization processing to be performed with the GPS satellite 310 (step S401). After the initialization processing in step S501 ends, the time server 102 transitions to an initial state and then advances the processing to step S502. In this initialization processing, setting values of various timers which are used in the present flow are determined. Conditions of setting values of timers which are used in the time server 102 are described below.

In step S502, the time server 102 sets the time server 102 itself as a synchronization master, and then advances the processing to step S503.

In step S503, the time server 102 transmits by multicast an Announce packet to a time synchronization network to which the time server 102 belongs (synchronous image capturing system 100). The Announce packet includes a data set about the time server 102 itself (the details thereof being described below). Examples of the Announce packet include an Announce packet defined in the IEEE 1588-2008 standard. In the following description, the Announce packet is described on the premise of the IEEE 1588-2008 standard. After the processing in step S503 ends, the time server 102 advances the processing to step S504.

In step S504, the time server 102 transitions to a master selection state, and then advances the processing to step S505. The master selection state is a period for determining a synchronization master in the synchronous image capturing system 100, and, in the master selection state, only transmission and reception of an Announce packet are performed out of communication packets for performing time synchronization.

In step S505, the time server 102 starts time measurement of a first timer and a second timer, and then advances the processing to step S506. The first timer is a timer for transmitting an Announce packet. The second timer is a timer for determining whether the synchronization master is operating in an appropriate manner.

In step S506, the time server 102 determines whether an Announce packet has been received. If it is determined that the Announce packet has been received (YES in step S506), the time server 102 advances the processing to step S507, and, if not so (NO in step S506), the time server 102 advances the processing to step S508.

In step S507, the time server 102 performs BMCA processing. The details of the BMCA processing are described below. Each time the BMCA processing is performed, a synchronization master is selected from two candidates (time servers 102a and 102b). When having received the first Announce packet after starting the present flow, the time server 102 compares a data set of the time server 102 itself and a data set included in the received packet with each other. Thus, a comparison in data set is performed between a synchronization master at the present moment and a new synchronization master candidate.

In step S508, the time server 102 determines whether the first timer has issued an event.

If it is determined that the first timer has issued an event (YES in step S508), the time server 102 advances the processing to step S509. If it is determined that the first timer has not yet issued an event (NO in step S508), the time server 102 advances the processing to step S512.

In step S509, the time server 102 determines whether the current synchronization master is the time server 102 itself. If it is determined that the current synchronization master is the time server 102 itself (YES in step S509), the time server 102 advances the processing to step S510, and, if not so (NO in step S509), the time server 102 advances the processing to step S512.

In step S510, the time server 102 transmits by multicast an Announce packet as with step S503, and then advances the processing to step S511.

In step S511, the time server 102 starts time measurement of the first timer, and then advances the processing to step S512.

In step S512, the time server 102 determines whether an end instruction has been detected (for example, whether a signal for issuing an instruction for ending has been received from the user terminal 170). If it is determined that the end instruction has been detected (YES in step S512), the time server 102 ends the processing in the present flow. If it is determined that the end instruction has not been detected (NO in step S512), the time server 102 advances the processing to step S513.

In step S513, the time server 102 determines whether the second timer has issued an event. If it is determined that the second timer has issued an event (YES in step S513), the time server 102 advances the processing to step S514, and, if it is determined that the second timer has not yet issued an event (NO in step S513), the time server 102 returns the processing to step S506.

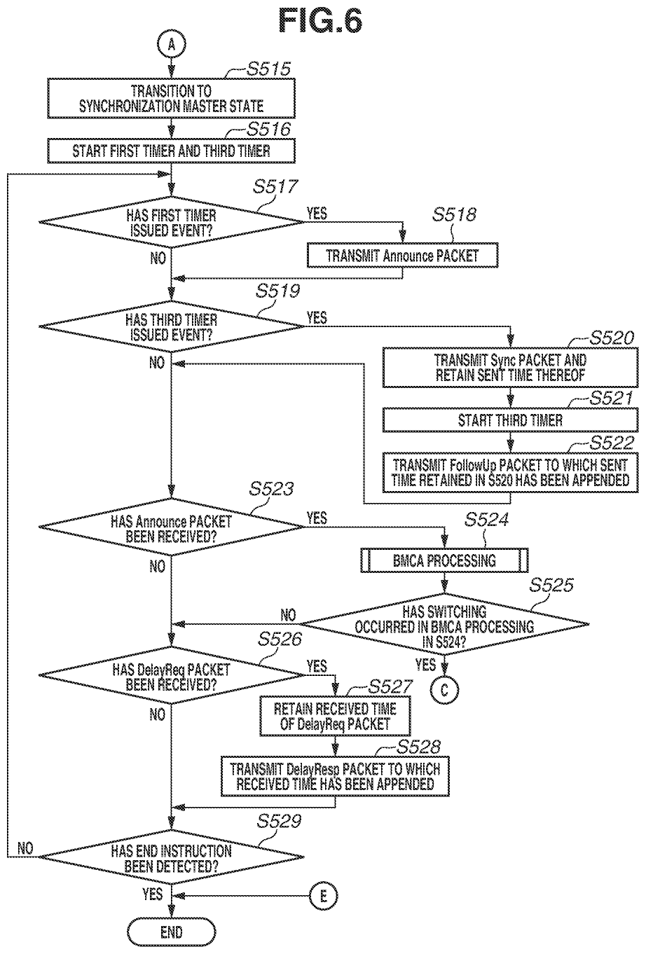

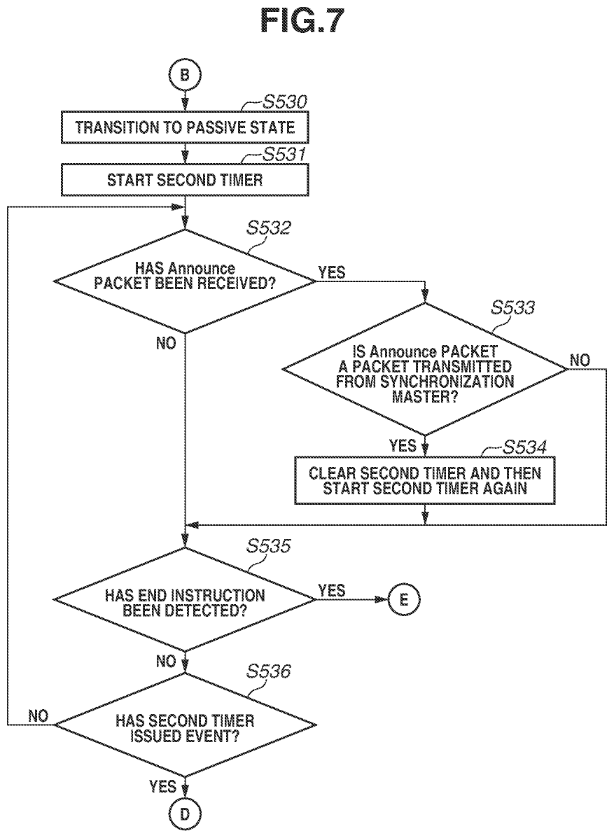

In step S514, the time server 102 determines whether the synchronization master is the time server 102 itself. If it is determined that the synchronization master is the time server 102 itself (YES in step S514), the time server 102 advances the processing to step S515 (FIG. 6), and, if not so (NO in step S514), the time server 102 advances the processing to step S530 (FIG. 7).

Next, processing which is performed after a result of the determination in step S514 illustrated in FIG. 5 has become YES is described with reference to FIG. 6.

In a case where a result of the determination in step S514 is YES, the time server 102 advances the processing to step S515.

In step S515, the time server 102 transitions to a synchronization master state. The synchronization master state is a state in which the time server 102 operates as a master device (terminal) for time synchronization within the synchronous image capturing system 100, and, in the synchronization master state, the time server 102 transmits not only an Announce packet but also a Sync packet and a DelayResp packet out of communication packets for performing time synchronization. Examples of the DelayResp packet include a Delay Response packet defined in the IEEE 1588-2008 standard. Hereinafter, unless otherwise stated, the DelayResp packet is assumed to be a Delay Response packet defined in the IEEE 1588-2008 standard. The synchronization slave terminal (camera adapter 101) receives these packets to become able to perform time synchronization.

In step S516, the time server 102 starts time measurement of the first timer and a third timer, and then advances the processing to step S517. The third timer is a timer for transmitting a Sync packet.

In step S517, the time server 102 determines whether the first timer has issued an event. If it is determined that the first timer has issued an event (YES in step S517), the time server 102 advances the processing to step S518. If it is determined that the first timer has not yet issued an event (NO in step S517), the time server 102 advances the processing to step S519.

In step S518, the time server 102 transmits by multicast an Announce packet as with step S503, and then advances the processing to step S519.

In step S519, the time server 102 determines whether the third timer has issued an event. If it is determined that the third timer has issued an event (YES in step S519), the time server 102 advances the processing to step S520. If it is determined that the third timer has not yet issued an event (NO in step S519), the time server 102 advances the processing to step S523.

In step S520, the time server 102 transmits by multicast a Sync packet, and retains sent time at which the time server 102 transmitted the Sync packet.

The sent time at which the time server 102 transmitted the Sync packet is acquired by use of a time stamp function of the network unit 302. Examples of the Sync packet include a Sync packet defined in the IEEE 1588-2008 standard. Furthermore, the transmission of a Sync packet can be not multicast transmission but unicast transmission. Generally, in the case of unicast transmission, a processing load on the time server 102 increases. Additionally, it is necessary to previously know a terminal which is synchronized with the time server 102. After processing in step S520 ends, the time server 102 advances the processing to step S521. Hereinafter, unless otherwise stated, the Sync packet is assumed to be a Sync packet defined in the IEEE 1588-2008 standard.

In step S521, the time server 102 starts time measurement of the third timer, and then advances the processing to step S522.

In step S522, the time server 102 transmits by multicast a FollowUp packet to which the sent time retained in step S520 has been appended. Furthermore, the transmission of the FollowUp packet can be unicast transmission as with step S520. Examples of the FollowUp packet include a FollowUp packet defined in the IEEE 1588-2008 standard. After processing in step S522 ends, the time server 102 advances the processing to step S523. Hereinafter, unless otherwise stated, the FollowUp packet is assumed to be a FollowUp packet defined in the IEEE 1588-2008 standard. Furthermore, the Sync packet, which is transmitted in step S520, and the FollowUp packet, which is transmitted in step S522, are assigned the same SequenceId. This enables a synchronization slave terminal to check the SequenceId to determine a FollowUp packet corresponding to the Sync packet.

In step S523, the time server 102 determines whether an Announce packet has been received as with step S506. If it is determined that the Announce packet has been received (YES in step S523), the time server 102 advances the processing to step S524, and, if not so (NO in step S523), the time server 102 advances the processing to step S526.

In step S524, the time server 102 performs BMCA processing as with step S507, and then advances the processing to step S525.

In step S525, the time server 102 determines whether switching of a synchronization master has occurred due to the BMCA processing performed in step S524. If it is determined that switching of a synchronization master has occurred (YES in step S525), the time server 102 returns the processing to step S504 (FIG. 5), and, if not so (NO in step S525), the time server 102 advances the processing to step S526.

In step S526, the time server 102 determines whether a DelayReq packet has been received from the camera adapter 101, which is a synchronization slave terminal. If it is determined that the DelayReq packet has been received (YES in step S526), the time server 102 advances the processing to step S527, and, if not so (NO in step S526), the time server 102 advances the processing to step S529. Furthermore, examples of the DelayReq packet include a Delay Request packet defined in the IEEE 1588-2008 standard. Hereinafter, unless otherwise stated, the DelayReq packet is assumed to be a Delay Request packet defined in the IEEE 1588-2008 standard.

In step S527, the time server 102 retains received time at which the time server 102 received the DelayReq packet in step S526.

The received time at which the time server 102 received the DelayReq packet is acquired by use of the time stamp function of the network unit 302. After processing in step S527 ends, the time server 102 advances the processing to step S528.

In step S528, the time server 102 transmits by multicast a DelayResp packet to which the received time retained in step S527 has been appended. Furthermore, the DelayResp packet can be transmitted by unicast to a sender of the DelayReq packet.

In step S529, the time server 102 determines whether an end instruction has been detected. If it is determined that the end instruction has been detected (YES in step S529), the time server 102 ends the processing in the present flow. If it is determined that the end instruction has not been detected (NO in step S529), the time server 102 returns the processing to step S517.

Next, processing which is performed after a result of the determination in step S514 illustrated in FIG. 5 has become NO is described with reference to FIG. 7. In a case where a result of the determination in step S514 is NO, the time server 102 advances the processing to step S530.

In step S530, the time server 102 transitions to a passive state. The passive state is a state in which, since a synchronization master other than the time server 102 itself exists in the synchronous image capturing system 100, the time server 102 waits until detecting that the existing synchronization master is not operating as a synchronization master (the existing synchronization master disappears). Accordingly, the time server 102 performs only monitoring of an Announce packet which a synchronization master periodically transmits. Furthermore, while, in the following description, the phrase “a synchronization master disappears” is used, the term “disappear” does not mean physically vanishing, but is used to express a state in which the existing synchronization master becomes not operating as a synchronization master.

In step S531, the time server 102 starts time measurement of the second timer, and then advances the processing to step S532.

In step S532, the time server 102 determines whether an Announce packet has been received. If it is determined that the Announce packet has been received (YES in step S532), the time server 102 advances the processing to step S533, and, if not so (NO in step S532), the time server 102 advances the processing to step S535.

In step S533, the time server 102 determines whether the Announce packet received in step S532 is a packet transmitted from a synchronization master. If it is determined that the received Announce packet is a packet transmitted from a synchronization master (YES in step S533), the time server 102 advances the processing to step S534, and, if not so (NO in step S533), the time server 102 advances the processing to step S535.

In step S534, the time server 102 clears the second timer and then starts time measurement of the second timer again, and then advances the processing to step S535.

In step S535, the time server 102 determines whether an end instruction has been detected. If it is determined that the end instruction has been detected (YES in step S535), the time server 102 ends the processing in the present flow. If it is determined that the end instruction has not been detected (NO in step S535), the time server 102 advances the processing to step S536.

In step S536, the time server 102 determines whether the second timer has issued an event. If it is determined that the second timer has issued an event (YES in step S536), the time server 102 returns the processing to step S502 (FIG. 5), and, if not so (NO in step S536), the time server 102 returns the processing to step S532.

With the above-described flow, when in the synchronization master state, the time server 102 performs processing of time synchronization packets such as a Sync packet at regular intervals, thus enabling the camera adapter 101 serving as a time synchronization slave to perform time synchronization.

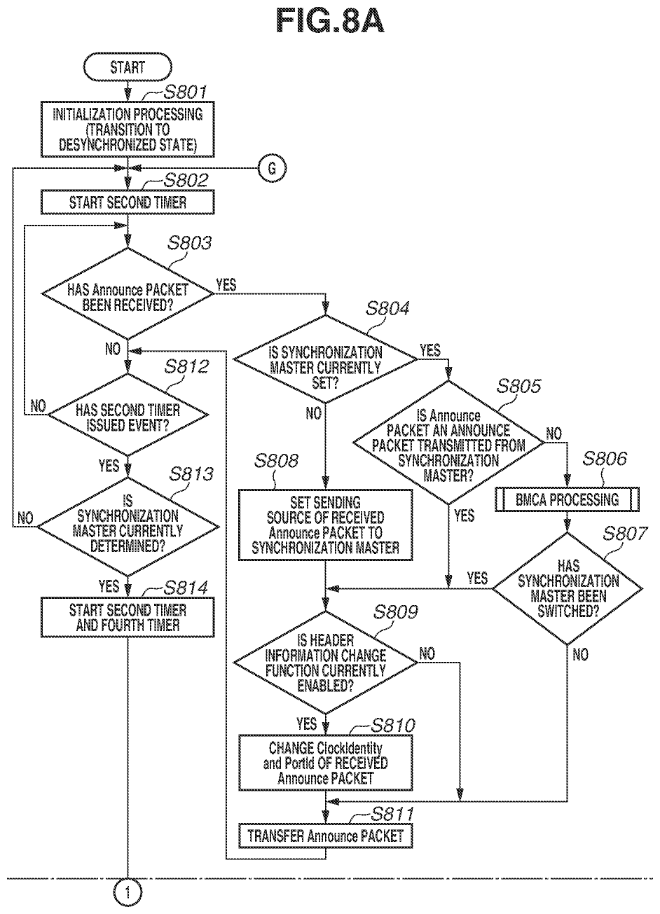

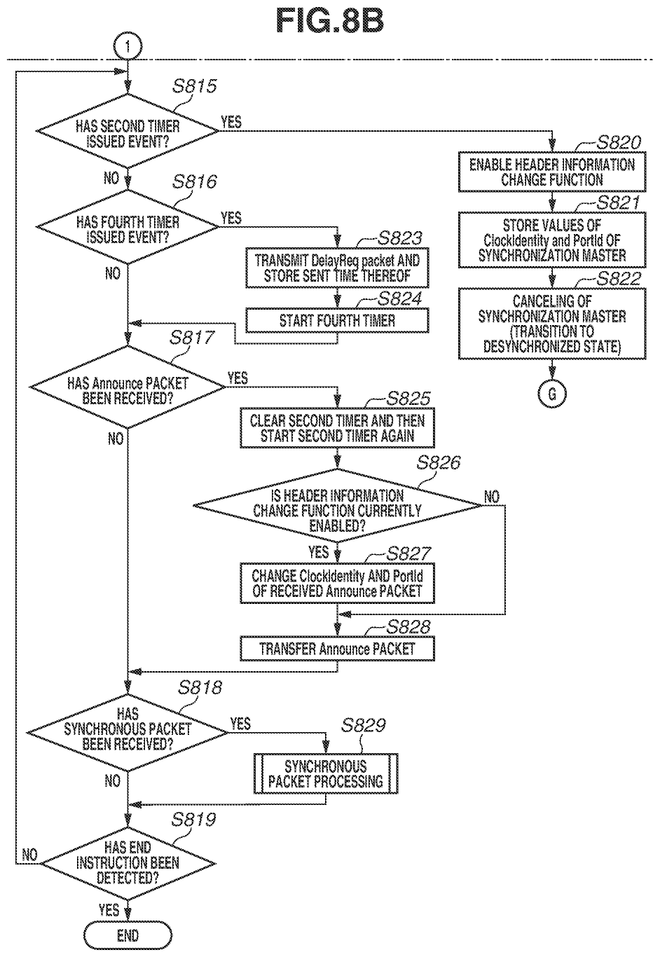

Next, a time synchronization processing flow of the camera adapter 101 is described with reference to FIGS. 8A and 8B.

The present flow starts in response to the camera adapter 101 being powered on and a time synchronization process being started up. Moreover, after the present flow ends, in a case where the time synchronization process has been started up again, the present flow also starts.

In step S801, the camera adapter 101 performs initialization processing for implementing time synchronization of the synchronous image capturing system 100. The initialization processing includes, for example, register setting of the network unit 202. Furthermore, in the initialization processing, setting values of various timers which are used in the present flow are determined.

Conditions of setting values of timers which are used in the camera adapter 101 are described below. When processing in step S801 has ended, the camera adapter 101 transitions to a desynchronized state, and then advances the processing to step S802. Furthermore, while, in the present flow, two types of timers (a second timer and a fourth timer) are used, a timer (second timer) which has the same use application as that of the timer which is used in the flow (FIG. 5 to FIG. 7) of the time server 102 is assigned the same name for descriptive purposes. The fourth timer is a timer which is used for the camera adapter 101 to transmit a DelayReq packet.

In step S802, the camera adapter 101 starts time measurement of the second timer, and then advances the processing to step S803.

In step S803, the camera adapter 101 determines whether an Announce packet has been received. If it is determined that the Announce packet has been received (YES in step S803), the camera adapter 101 advances the processing to step S804, and, if not so (NO in step S803), the camera adapter 101 advances the processing to step S812.

In step S804, the camera adapter 101 determines whether a synchronization master is currently set. If it is determined that a synchronization master is currently set (YES in step S804), the camera adapter 101 advances the processing to step S805, and, if not so (NO in step S804), the camera adapter 101 advances the processing to step S808.

In step S805, the camera adapter 101 determines whether the Announce packet received in step S803 is an Announce packet transmitted from a synchronization master. If it is determined that the received Announce packet is an Announce packet transmitted from a synchronization master (YES in step S805), the camera adapter 101 advances the processing to step S809, and, if not so (NO in step S805), the camera adapter 101 advances the processing to step S806.

In step S806, the camera adapter 101 performs BMCA processing, and then advances the processing to step S807.

In step S807, the camera adapter 101 determines whether a synchronization master has been switched due to the BMCA processing performed in step S806. If it is determined that a synchronization master has been switched (YES in step S807), the camera adapter 101 advances the processing to step S809, and, if not so (NO in step S807), the camera adapter 101 advances the processing to step S811.

In step S808, the camera adapter 101 sets the sending source of the received Announce packet to a synchronization master, and then advances the processing to step S809.

In step S809, the camera adapter 101 determines whether a header information change function is currently enabled. If it is determined that the header information change function is currently enabled (YES in step S809), the camera adapter 101 advances the processing to step S810, and, if not so (NO in step S809), the camera adapter 101 advances the processing to step S811. The outline and effect of the header information change function are described below.

In step S810, the camera adapter 101 changes ClockIdentity and PortId of the received Announce packet, and then advances the processing to step S811.

In step S811, the camera adapter 101 transfers the Announce packet to a port other than the port via which the Announce packet has been received, and then advances the processing to step S812. Furthermore, in a case where the camera adapter 101 has advanced the processing to step S811 via step S810, the camera adapter 101 transfers the Announce packet the values of which have been changed.

In step S812, the camera adapter 101 determines whether the second timer has issued an event. If it is determined that the second timer has issued an event (YES in step S812), the camera adapter 101 advances the processing to step S813, and, if not so (NO in step S812), the camera adapter 101 returns the processing to step S803.

In step S813, the camera adapter 101 determines whether a synchronization master is currently determined. If it is determined that a synchronization master is currently determined (YES in step S813), the camera adapter 101 advances the processing to step S814, and, if not so (NO in step S813), the camera adapter 101 returns the processing to step S802.

In step S814, the camera adapter 101 starts time measurement of the second timer and the fourth timer, and then advances the processing to step S815.

In step S815, the camera adapter 101 determines whether the second timer has issued an event. If it is determined that the second timer has issued an event (YES in step S815), the camera adapter 101 advances the processing to step S820, and, if not so (NO in step S815), the camera adapter 101 advances the processing to step S816.

In step S816, the camera adapter 101 determines whether the fourth timer has issued an event. If it is determined that the fourth timer has issued an event (YES in step S816), the camera adapter 101 advances the processing to step S823, and, if not so (NO in step S816), the camera adapter 101 advances the processing to step S817.

In step S817, the camera adapter 101 determines whether an Announce packet has been received. If it is determined that the Announce packet has been received (YES in step S817), the camera adapter 101 advances the processing to step S825, and, if not so (NO in step S817), the camera adapter 101 advances the processing to step S818.

In step S818, the camera adapter 101 determines whether a synchronous packet has been received. If it is determined that the synchronous packet has been received (YES in step S818), the camera adapter 101 advances the processing to step S829, and, if not so (NO in step S818), the camera adapter 101 advances the processing to step S819. Furthermore, the synchronous packet refers to any one of a Sync packet, a FollowUp packet, a DelayReq packet, and a DelayResp packet.

In step S819, the camera adapter 101 determines whether an end instruction has been detected. If it is determined that the end instruction has been detected (YES in step S819), the camera adapter 101 ends the processing in the present flow, and, if not so (NO in step S819), the camera adapter 101 returns the processing to step S815.

In step S820, the camera adapter 101 enables the header information change function, and then advances the processing to step S821.

In step S821, the camera adapter 101 stores the values of ClockIdentity and PortId of a synchronization master, and then advances the processing to step S822.

In step S822, the camera adapter 101 performs canceling of a synchronization master and transitions to a desynchronized state, and then returns the processing to step S802. Along with canceling of a synchronization master, for example, a stay time, received time, sent time, and other calculated values which have been used for time synchronization up to now are reset.

In step S823, the camera adapter 101 transmits by multicast a DelayReq packet, and stores sent time at which the camera adapter 101 transmitted the DelayReq packet. Furthermore, the transmission of the DelayReq packet can be unicast transmission. The sent time is acquired by use of a time stamp function of the network unit 202.

In step S824, the camera adapter 101 starts time measurement of the fourth timer, and then advances the processing to step S817.

In step S825, the camera adapter 101 clears the second timer and then starts time measurement of the second timer again, and then advances the processing to step S826.

In step S826, the camera adapter 101 determines whether the header information change function is currently enabled. If it is determined that the header information change function is currently enabled (YES in step S826), the camera adapter 101 advances the processing to step S827, and, if not so (NO in step S826), the camera adapter 101 advances the processing to step S828.

In step S827, the camera adapter 101 changes ClockIdentity and PortId of the received Announce packet as with step S810, and then advances the processing to step S828.

In step S828, the camera adapter 101 transfers the Announce packet as with step S811, and then advances the processing to step S818.

In a case where the camera adapter 101 has advanced the processing to step S828 via step S827, the camera adapter 101 transfers the Announce packet the values of which have been changed.

In step S829, the camera adapter 101 performs synchronous packet processing on the received synchronous packet.

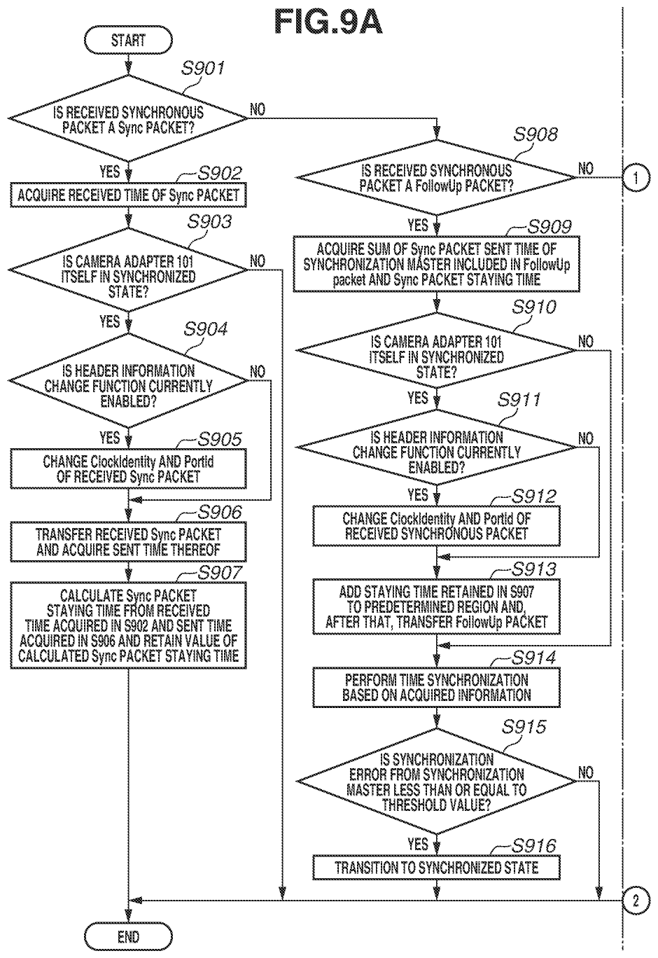

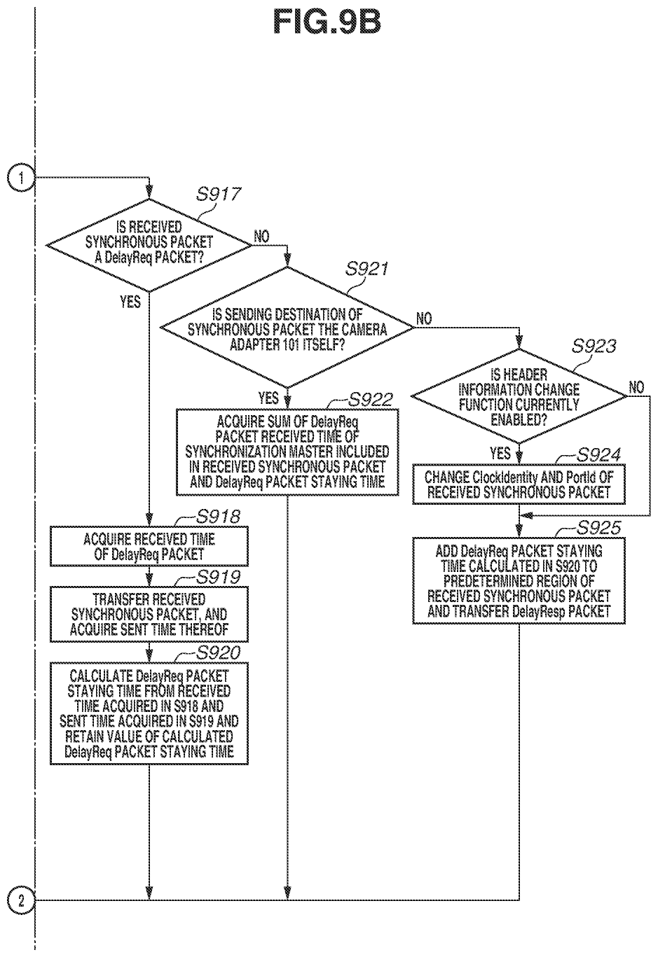

Next, a flow for synchronous packet processing is described with reference to FIGS. 9A and 9B.

In step S901, the camera adapter 101 determines whether the received synchronous packet is a Sync packet. If it is determined that the received synchronous packet is a Sync packet (YES in step S901), the camera adapter 101 advances the processing to step S902, and, if not so (NO in step S901), the camera adapter 101 advances the processing to step S908.

In step S902, the camera adapter 101 acquires the received time of the received Sync packet, and then advances the processing to step S903. The received time is acquired by use of the time stamp function of the network unit 202.

In step S903, the camera adapter 101 determines whether the camera adapter 101 itself is in the synchronized state. If it is determined that the camera adapter 101 itself is in the synchronized state (YES in step S903), the camera adapter 101 advances the processing to step S904, and, if not so (NO in step S903), the camera adapter 101 ends the processing in the present flow.

In step S904, the camera adapter 101 determines whether the header information change function is currently enabled. If it is determined that the header information change function is currently enabled (YES in step S904), the camera adapter 101 advances the processing to step S905, and, if not so (NO in step S904), the camera adapter 101 advances the processing to step S906.

In step S905, the camera adapter 101 changes ClockIdentity and PortId (header information) of the received Sync packet, and then advances the processing to step S906.

In step S906, the camera adapter 101 transfers the received Sync packet and acquires the sent time thereof, and then advances the processing to step S907. In a case where the camera adapter 101 has advanced the processing to step S906 via step S905, the camera adapter 101 transfers the Sync packet the values of which have been changed in step S905. The sent time is acquired by use of the time stamp function of the network unit 202.

In step S907, the camera adapter 101 calculates a Sync packet staying time from the received time acquired in step S902 and the sent time acquired in step S906 and retains the value of the calculated Sync packet staying time, and ends the processing in the present flow.

In step S908, the camera adapter 101 determines whether the received synchronous packet is a FollowUp packet. If it is determined that the received synchronous packet is a FollowUp packet (YES in step S908), the camera adapter 101 advances the processing to step S909, and, if not so (NO in step S908), the camera adapter 101 advances the processing to step S917.

In step S909, the camera adapter 101 acquires (calculates) the sum of Sync packet sent time of a synchronization master included in the FollowUp packet and the Sync packet staying time, and then advances the processing to step S910.

In step S910, the camera adapter 101 determines whether the camera adapter 101 itself is in the synchronized state. If it is determined that the camera adapter 101 itself is in the synchronized state (YES in step S910), the camera adapter 101 advances the processing to step S911, and, if not so (NO in step S910), the camera adapter 101 advances the processing to step S914.

In step S911, the camera adapter 101 determines whether the header information change function is currently enabled. If it is determined that the header information change function is currently enabled (YES in step S911), the camera adapter 101 advances the processing to step S912, and, if not so (NO in step S911), the camera adapter 101 advances the processing to step S913.

In step S912, the camera adapter 101 changes ClockIdentity and PortId of the received synchronous packet, and then advances the processing to step S913.

In step S913, the camera adapter 101 adds the staying time retained in step S907 to a predetermined region of the FollowUp packet and, after that, transfers the FollowUp packet. In a case where the camera adapter 101 has advanced the processing to step S913 via step S912, the camera adapter 101 transfers the FollowUp packet the values of which have been changed in step S912.

In step S914, the camera adapter 101 performs time synchronization based on the acquired information. The details thereof are described below.

In step S915, the camera adapter 101 determines whether, as a result of processing in step S914, a synchronization error from the synchronization master is less than or equal to a threshold value. If it is determined that the synchronization error from the synchronization master is less than or equal to the threshold value (YES in step S915), the camera adapter 101 advances the processing to step S916, and, if not so (NO in step S915), the camera adapter 101 directly ends the processing in the present flow.

In step S916, the camera adapter 101 itself transitions to the synchronized state, and then ends the processing in the present flow.

In step S917, the camera adapter 101 determines whether the received synchronous packet is a DelayReq packet. If it is determined that the received synchronous packet is a DelayReq packet (YES in step S917), the camera adapter 101 advances the processing to step S918, and, if not so (NO in step S917), the camera adapter 101 advances the processing to step S921.

In step S918, the camera adapter 101 acquires the received time of the DelayReq packet, and then advances the processing to step S919. The received time is acquired by use of the time stamp function of the network unit 202.

In step S919, the camera adapter 101 transfers the received DelayReq packet, and acquires sent time thereof. The sent time is acquired by use of the time stamp function of the network unit 202.

In step S920, the camera adapter 101 calculates a DelayReq packet staying time from the received time acquired in step S918 and the sent time acquired in step S919 and retains the value of the calculated DelayReq packet staying time. Then, the camera adapter 101 ends the processing in the present flow.

In step S921, the camera adapter 101 determines whether the sending destination of the synchronous packet is the camera adapter 101 itself. If it is determined that the synchronous packet is directed to the camera adapter 101 itself (YES in step S921), the camera adapter 101 advances the processing to step S922, and, if not so (NO in step S921), the camera adapter 101 advances the processing to step S923. The synchronous packet which is received in the present flow is a DelayResp packet.

In step S922, the camera adapter 101 acquires the sum of a DelayReq packet received time of a synchronization master included in the received synchronous packet and the DelayReq packet staying time, and then ends the processing in the present flow.

In step S923, the camera adapter 101 determines whether the header information change function is currently enabled. If it is determined that the header information change function is currently enabled (YES in step S923), the camera adapter 101 advances the processing to step S924, and, if not so (NO in step S923), the camera adapter 101 advances the processing to step S925.

In step S924, the camera adapter 101 changes ClockIdentity and PortId of the received synchronous packet (DelayResp packet), and then advances the processing to step S925.

In step S925, the camera adapter 101 adds the DelayReq packet staying time calculated in step S920 to a predetermined region of the DelayResp packet and transfers the DelayResp packet with the DelayReq packet staying time added thereto, and then ends the processing in the present flow. Furthermore, in a case where the camera adapter 101 has advanced the processing to step S925 via step S924, the camera adapter 101 uses the DelayResp packet the values of which have been changed in step S924.

The header information change function is described. The camera adapter 101, which is a synchronization slave terminal, determines a synchronization master and, after that, monitors an Announce packet which is periodically transmitted and incoming.

While, if an Announce packet ceases being transmitted and incoming within a predetermined time, it is necessary to switch a synchronization master, to perform BMCA processing again and wait for the second timer to issue an event, a certain amount of time is required before processing for time synchronization (step S914) is performed. Additionally, even if a synchronization master is currently set, until a synchronization slave terminal enters into a synchronized state, transfer of a synchronous packet is not performed. In a case where a synchronous network (synchronous image capturing system 100) is configured as a daisy chain such as the synchronous image capturing system 100 in the first exemplary embodiment, it takes a time before all of the synchronization slave terminals (camera adapters 101a to 101z) are synchronized with each other. The reason why not to transmit a synchronous packet before the synchronization slave terminal enters into a synchronized state is because, if a synchronous packet is transferred in a state in which the synchronization slave terminal is in the desynchronized state, the accuracy of a staying time included in a synchronous packet is low. Thus, there is a risk that, when the control terminal 180 has checked a synchronized state of the camera adapter 101 serving as a synchronization slave, although a desired synchronization accuracy has not been obtained, the control terminal 180 may erroneously recognize that the camera adapter 101 is in the synchronized state.

Therefore, in the first exemplary embodiment, a time information change function (header information change function) is used. More specifically, in a case where a synchronization master has disappeared (a case where a synchronous packet has not been able to be received within a predetermined time), a packet (header information change packet) having header information the content of which is the same as that of a packet which the synchronization master has transmitted before disappearing is transmitted to a synchronization slave. The synchronization slave (camera adapter 101) receiving the header information change packet is able to recognize as if the synchronization master before disappearing is transmitting a packet, and, therefore, does not detect disappearance of the synchronization master. Thus, the synchronization slave becomes able to recognize a new synchronization master which has started operating as the former synchronization master (the synchronization master which has disappeared), then continuing synchronization processing. Such a header information change is performed by, for example, the camera adapter 101a, and a synchronous packet including the changed header information is transmitted from the camera adapter 101a to the downstream-side camera adapters 101b to 101z. Therefore, in the camera adapters 101b to 101z, the occurrence of a synchronization error can be prevented or reduced.

It is favorable that, in the synchronous image capturing system 100 in the first exemplary embodiment, header information change processing for a packet is performed by the camera adapter 101a, which is closest to the time server 102. For that purpose, the camera adapter 101a has to detect the disappearance of a synchronization master earlier than the camera adapters 101b to 101z. The time server 102a or the time server 102b also needs to detect the disappearance of a synchronization master at the same timing as the camera adapter 101a. Thus, the camera adapter 101a and the time server 102 operate with the same second timer time (referred to as “M”), and the second timer time (referred to as “N”) for the camera adapters 101b to 101z is set larger than “M”. Additionally, the first timer time (referred to as “O”), which is a transmission interval for an Announce packet transmitted by the time server 102, has to be taken into consideration in such a manner that the second time does not issue.

With the above issues taken into consideration, “N” needs to be larger than at least the sum of “M” which is a time required until detection (detection of the disappearance of a synchronization master), “M” which is a time required for determination of a new synchronization master, and “O” which is a time required until an Announce packet is transmitted. Additionally, it is necessary to determine timer settings also in consideration of a time “X” which is required until an Announce packet arrives at the camera adapter 101z located on the tail end. The time “X” can be previously measured to be set, or the camera adapter 101z can be configured to communicate the time “X” to the time server 102. The camera adapter 101 is able to calculate the time “X” from a DelayReq packet transmission time and a DelayReq packet reception time included in the DelayResp packet. Moreover, the communication of the time “X” can be performed via the control terminal 180.

Next, ClockIdentity and PortId, which are changed by the header information change function, are described. Each of the above-mentioned two pieces of information (ClockIdentity and PortId) is information included in the header of a Precision Time Protocol (PTP) packet. ClockIdentity is information composed of eight bytes, in which higher three bytes and lower three bytes of a media access control (MAC) address serving as a sending source of a notification packet are mapped to the first three bytes and the last three bytes out of eight bytes, respectively.

Then, the middle two bytes are set with 0xFF and 0xFE. PortId is equivalent to a port number which the sender of a notification packet has used, and is two-byte information. Two pieces of information (ClockIdentity and PortId) may sometimes be managed in combination as SourcePortldentity. Thus, changing ClockIdentity and PortId is synonymous with changing SourcePortldentity. Moreover, not only a PTP header but also ClockIdentity and PortId included in PTP data can be changed. The target to be changed is GM Identity described below.

A data set which is used in the Best Master Clock Algorithm (BMCA) is described. The data set is composed of the following nine pieces of information:
(1) GM Identity Identification code of a grandmaster (GM);
(2) GM Priority1 Priority 1 of GM;
(3) GM Clock Class Traceability of GM;
(4) GM Clock Accuracy Time accuracy of GM;
(5) GM OffsetScaled Log Variance Phase fluctuation of GM;
(6) GM Priority2 Priority 2 of GM;
(7) StepsRemoved Number of connection steps from GM;
(8) PortIdentity Port identification number; and
(9) portNumber Port number.

Each of the pieces of information (1) to (9) is described.

The information (1) is information composed of eight bytes and is the same as ClockIdentity. Changing is performed on the information (1) when the header information change function has been enabled as needed.

The information (2) is information composed of one byte and, as the amount thereof is smaller, indicates higher priority. However, “0” is reserved for management operation, and “255” indicates that a terminal of interest is unable to become a grandmaster.

The information (3) is information composed of one byte, in which, for example, “6” indicates that the GM is currently synchronized with a primary basic time source such as the GPS and “7” indicates that, at the beginning, the GM has been synchronized with a primary source but, since then, has lost the capability of being synchronized with the source.

The information (4) is information composed of one byte, in which, for example, “0x20h” indicates a time error of 25 nanoseconds from a basic clocking signal.

The information (5) is information composed of two bytes and is an estimate value of PTP variance derived from Allan variance.

The information (6) is information composed of one byte, and, as the amount thereof is smaller, indicates higher priority as with the information (2).

The information (7) is information composed of two bytes and indicates the number of switches and hops to which a notification packet is passed. The present information is not changed by the camera adapter 101 or the hub 140, which operates with a TC.

The information (8) is information composed of ten bytes and is configured with the information (1) and a port number which the sender or receiver of a notification packet has used (equivalent to the information (9) and being two-byte information). The port number for the sender is able to be acquired from the PTP header. On the other hand, the port number for the receiver corresponds to a port used when a notification packet has been received. The information (8) and information (9) can be changed when the header information change function has been enabled as needed.

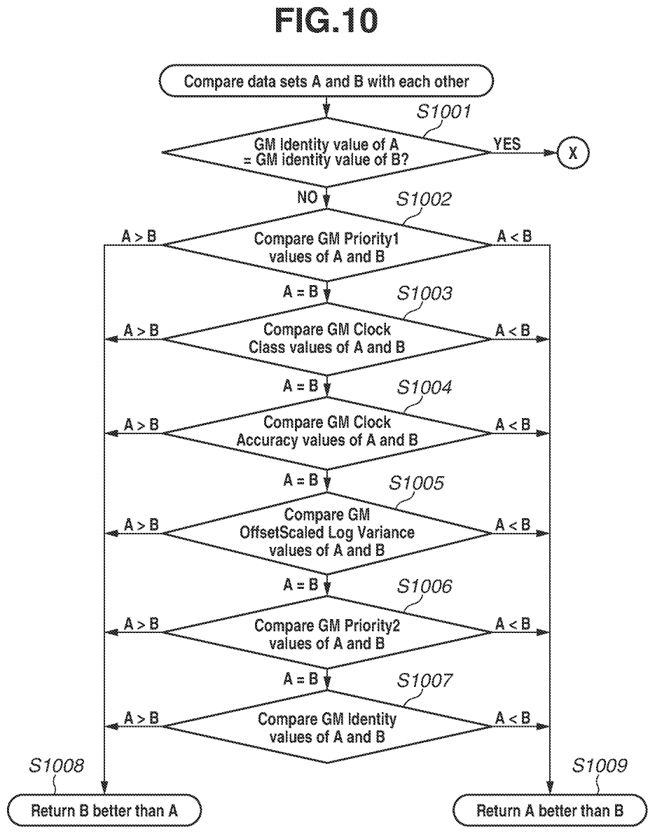

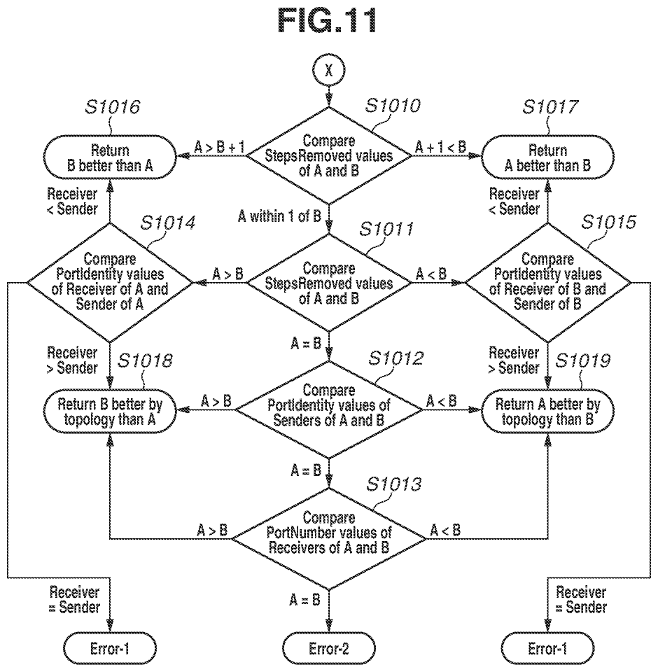

Next, a flow of the Best Master Clock Algorithm (BMCA) is described with reference to FIG. 10 and FIG. 11. Furthermore, the present flow (algorithm) is the same as BMCA defined in the IEEE 1588-2008 standard.

For convenience sake, an aggregate including the above-mentioned nine pieces of information (1) to (9) is referred to as a “data set”. The flow illustrated in FIG. 10 starts with the BMCA comparing two data sets, i.e., a data set A and a data set B, with each other.

In step S1001, the BMCA determines whether the information (1) of the data set A is equal to the information (1) of the data set B. If it is determined that the information (1) of the data set A is equal to the information (1) of the data set B (YES in step S1001), the BMCA advances the processing to step S1010 (FIG. 11), and, if not so (NO in step S1001), the BMCA advances the processing to step S1002.

In step S1002, the BMCA compares the information (2) of the data set A and the information (2) of the data set B with each other. The BMCA determines that a data set the value of the information (2) of which is smaller is a higher-priority data set. If a result of the comparison is “A>B” (A>B in step S1002), the BMCA advances the processing to step S1008, if a result of the comparison is “A<B” (A<B in step S1002), the BMCA advances the processing to step S1009, and, if a result of the comparison is “A=B” (A=B in step S1002), the BMCA advances the processing to step S1003.

In step S1003, the BMCA compares the information (3) of the data set A and the information (3) of the data set B with each other. The BMCA determines that a data set the value of the information (3) of which is smaller is a data set higher in traceability of the GM (the traceability to standard time: equivalent to an index indicating the reliability of time). If a result of the comparison is “A>B” (A>B in step S1003), the BMCA advances the processing to step S1008, if a result of the comparison is “A<B” (A<B in step S1003), the BMCA advances the processing to step S1009, and, if a result of the comparison is “A=B” (A=B in step S1003), the BMCA advances the processing to step S1004.

In step S1004, the BMCA compares the information (4) of the data set A and the information (4) of the data set B with each other. The BMCA determines that a data set the value of the information (4) of which is smaller is a higher-accuracy data set. If a result of the comparison is “A>B” (A>B in step S1004), the BMCA advances the processing to step S1008, if a result of the comparison is “A<B” (A<B in step S1004), the BMCA advances the processing to step S1009, and, if a result of the comparison is “A=B” (A=B in step S1004), the BMCA advances the processing to step S1005.

In step S1005, the BMCA compares the information (5) of the data set A and the information (5) of the data set B with each other. The BMCA determines that a data set the value of the information (5) of which is smaller is a data set smaller in phase fluctuation. If a result of the comparison is “A>B” (A>B in step S1005), the BMCA advances the processing to step S1008, if a result of the comparison is “A<B” (A<B in step S1005), the BMCA advances the processing to step S1009, and, if a result of the comparison is “A=B” (A=B in step S1005), the BMCA advances the processing to step S1006.

In step S1006, the BMCA compares the information (6) of the data set A and the information (6) of the data set B with each other. The BMCA determines that a data set the value of the information (6) of which is smaller is a higher-priority data set. If a result of the comparison is “A>B” (A>B in step S1006), the BMCA advances the processing to step S1008, if a result of the comparison is “A<B” (A<B in step S1006), the BMCA advances the processing to step S1009, and, if a result of the comparison is “A=B” (A=B in step S1006), the BMCA advances the processing to step S1007.

In step S1007, the BMCA compares the information (1) of the data set A and the information (1) of the data set B with each other. The BMCA determines that a data set the value of the information (1) of which is smaller is a data set to be preferentially selected. If a result of the comparison is “A>B” (A>B in step S1007), the BMCA advances the processing to step S1008, and, if a result of the comparison is “A<B” (A<B in step S1007), the BMCA advances the processing to step S1009.

In step S1008, the BMCA determines the sending source of the data set B as a best master, and then ends the processing in the present flow.

In step S1009, the BMCA determines the sending source of the data set A as a best master, and then ends the processing in the present flow.

FIG. 11 illustrates processing which is performed in a case where the result of determination in step S1001 illustrated in FIG. 10 is YES.

In step S1010, the BMCA compares the information (7) of the data set A and the information (7) of the data set B with each other.

If, as a result of the comparison, the number of connection steps for the data set A is within one step of the number of connection steps for the data set B (A within 1 of B in step S1010), the BMCA advances the processing to step S1011, if a result of the comparison is “A>B+1” (if the number of connection steps for the data set A is larger than a number of steps obtained by adding one step to the number of connection steps for the data set B) (A>B+1 in step S1010), the BMCA advances the processing to step S1016, and, if a result of the comparison is “A+1<B” (if the number of connection steps for the data set B is larger than a number of steps obtained by adding one step to the number of connection steps for the data set A) (A+1<B in step S1010), the BMCA advances the processing to step S1017.

In step S1011, the BMCA compares the information (7) of the data set A and the information (7) of the data set B with each other.

If a result of the comparison is “A=B” (if the numbers of connection steps from the GM are equal) (A=B in step S1011), the BMCA advances the processing to step S1012, if a result of the comparison is “A>B” (if the number of connection steps for the data set A is larger) (A>B in step S1011), the BMCA advances the processing to step S1014, and, if a result of the comparison is “A<B” (if the number of connection steps for the data set B is larger) (A<B in step S1011), the BMCA advances the processing to step S1015.

In step S1012, the BMCA compares the information (8) of the sender of the data set A and the information (8) of the sender of the data set B with each other. If a result of the comparison is “A=B” (A=B in step S1012), the BMCA advances the processing to step S1013, if a result of the comparison is “A>B” (A>B in step S1012), the BMCA advances the processing to step S1018, and, if a result of the comparison is “A<B” (A<B in step S1012), the BMCA advances the processing to step S1019.

In step S1013, the BMCA compares the information (9) of the receiver of the data set A and the information (9) of the receiver of the data set B with each other. If a result of the comparison is “A=B” (A=B in step S1013), the BMCA ends the processing in the present flow (Error-2), if a result of the comparison is “A>B” (A>B in step S1013), the BMCA advances the processing to step S1018, and, if a result of the comparison is “A<B” (A<B in step S1013), the BMCA advances the processing to step S1019.

In step S1014, the BMCA compares the information (8) of the receiver of the data set A and the information (8) of the sender of the data set A with each other. If a result of the comparison is “Receiver=Sender” (Receiver=Sender in step S1014), the BMCA ends the processing in the present flow (Error-1), if a result of the comparison is “Receiver<Sender” (Receiver<Sender in step S1014), the BMCA advances the processing to step S1016, and, if a result of the comparison is “Receiver>Sender” (Receiver>Sender in step S1014), the BMCA advances the processing to step S1018.

In step S1015, the BMCA compares the information (8) of the receiver of the data set B and the information (8) of the sender of the data set B with each other. If a result of the comparison is “Receiver=Sender” (Receiver=Sender in step S1015), the BMCA ends the processing in the present flow (Error-1), if a result of the comparison is “Receiver<Sender” (Receiver<Sender in step S1015), the BMCA advances the processing to step S1017, and, if a result of the comparison is “Receiver>Sender” (Receiver>Sender in step S1015), the BMCA advances the processing to step S1019.

In step S1016, the BMCA determines the sending source of the data set B as a best master as with step S1008, and then ends the processing in the present flow.

In step S1017, the BMCA determines the sending source of the data set A as a best master as with step S1009, and then ends the processing in the present flow.

In step S1018, the BMCA determines the sending source of the data set B, which is better in topology (network connection configuration) than the data set A, as a best master, and then ends the processing in the present flow.

In step S1019, the BMCA determines the sending source of the data set A, which is better in topology than the data set B, as a best master, and then ends the processing in the present flow.

The above-described flow enables a terminal which executes the BMCA to determine a synchronization master.

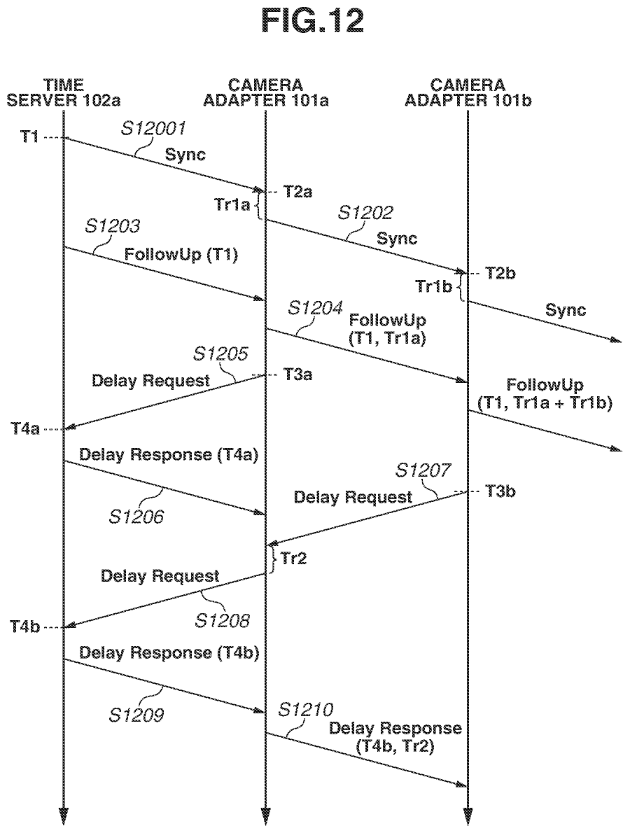

Next, a time synchronization sequence which is performed between the time server 102a and the camera adapters 101 is described with reference to FIG. 12. In the sequence illustrated in FIG. 12, a Sync packet and a FollowUp packet which the time server 102a transmits are assumed to be transmitted by multicast.

Furthermore, the first exemplary embodiment is not limited to multicast transmission. However, in the case of unicast transmission, the camera adapter 101 needs to start with a promiscuous mode to become able to receive a synchronous packet directed to another camera adapter. Furthermore, for the sake of explanation, the camera adapter 101 is assumed to be in the synchronized state and the header information change function is assumed to be in the disabled state.

In step S1201, the time server 102a transmits a Sync packet. Then, the time server 102a retains sent time T1 (equivalent to step S520). The camera adapter 101a, having received the Sync packet, acquires received time T2a (equivalent to step S902), and, in step S1202, performs transfer of the Sync packet (equivalent to step S906). Furthermore, when transferring the Sync packet, the camera adapter 101a also acquires the sent time and also calculates a staying time Tr1a in the camera adapter 101a.

The camera adapter 101b, having received the transferred Sync packet, acquires received time T2b (equivalent to step S902), calculates a staying time Tr1b in a similar way, and performs transfer of the Sync packet.

In step S1203, the time server 102a transmits a FollowUp packet including information about the sent time T1 previously retained in step S520 (equivalent to step S522).

In step S1204, the camera adapter 101a, having received the FollowUp packet, acquires the sent time T1 included in the FollowUp packet, and acquires the sum of the staying time of the Sync packet (equivalent to step S909). Then, the camera adapter 101a adds the calculated staying time Tr1a to a predetermined region of the the FollowUp packet and transfers the FollowUp packet (equivalent to step S913) and, after that, performs calculation of time synchronization (equivalent to step S914), but, since, at the time of step S1204, information required for calculation of time synchronization is insufficient, such processing is skipped.

In step S1205, the camera adapter 101a transmits a DelayReq packet to time server 102a, and acquires the sent time T3a thereof (equivalent to step S823). The time server 102a, having received the DelayReq packet, retains received time T4a thereof (equivalent to step S527).

In step S1206, the time server 102a transmits a DelayResp packet to the camera adapter 101a, which is a sender of the DelayReq packet received in step S1205. Furthermore, the DelayResp packet includes information about the received time T4a of the DelayReq packet retained in step S1205 (equivalent to step S528). The camera adapter 101a, having received the DelayResp packet, acquires information about the received time T4a included in the DelayResp packet (equivalent to step S922), and, additionally, also acquires the sum of the staying time of the DelayReq packet.

In step S1207, the camera adapter 101b transmits a DelayReq packet to the camera adapter 101a as with step S1205, and acquires sent time T3b thereof (equivalent to step S823).

In step S1208, the camera adapter 101a, having received the DelayReq packet, transfers the DelayReq packet to the time server 102a (equivalent to step S919). The camera adapter 101a retains a staying time Tr2 of the DelayReq packet from the received time and sent time obtained at the time of transfer of the DelayReq packet (equivalent to step S920). The time server 102a, having received the DelayReq packet, retains received time T4b thereof (equivalent to step S527).

In step S1209, the time server 102a transmits a DelayResp packet to the camera adapter 101a, which is the sender of the DelayReq packet received in step S1208, as with step S1206. Furthermore, the DelayResp packet includes information about the received time T4b of the DelayReq packet retained in step S1208 (equivalent to step S528). The camera adapter 101a, having received the DelayResp packet, which is not directed to the camera adapter 101a itself, checks the sending destination of the DelayResp packet. Then, in step S1210, the camera adapter 101a adds the staying time of the DelayReq packet corresponding to the checked sending destination (in this example, corresponding to the staying time Tr2) to a predetermined region of the DelayResp packet, and transfers the DelayResp packet to the camera adapter 101b (equivalent to step S925). The camera adapter 101b, having received the DelayResp packet, which is directed to the camera adapter 101b itself, acquires information about the received time T4b included in the DelayResp packet and the staying time (Tr2) of the DelayReq packet (equivalent to step S922).

While, in FIG. 12, for the sake of explanation, only one round from a Sync packet to a DelayResp packet is illustrated, the present sequence being repeated enables performing time synchronization with use of the sent and received times (T1 to T4b) and the staying times (Tr1a to Tr2). The calculation method for time synchronization is described with the camera adapter 101b taken as an example.

An average transmission path delay between the time server 102a, which is a synchronization master, and the camera adapter 101b, which is a synchronization slave, can be calculated as follows:

Average transmission path delay=((T4b−T1)−(T3b−T2b))−(Tr1a+Tr2)/2.

Moreover, through the use of the average transmission path delay and the staying time of a Sync packet, a time correction amount (offset) relative to the time server 102a, which is a synchronization master, can be calculated as follows:

Time correction amount=T2b−T1−average transmission path delay−Tr1a.

Furthermore, the average transmission path delay and the time correction amount can be converted into general expressions as follows:

Average transmission path delay=((DelayReq received time−Sync sent time)−(Sync received time−DelayReq sent time))−(sum of Sync staying times+sum of DelayReq staying times)/2, and

Time correction amount=Sync received time−Sync sent time−average transmission path delay−sum of Sync staying times or sum of DelayReq staying times.

Additionally, when the time at which the time server 102a transmitted the second Sync packet is denoted by T5 and the time at which the transmitted packet was received by the camera adapter 101b is denoted by T6b, the following equations are used for calculation:

Frequency correction amount=(Fo−Fr)/Fr, and

Fr=1/(T5−T1), and Fo=1/(T6b−T2b).

Fr denotes a speed at which a timer on the sending side runs, and Fo denotes a speed at which a timer on the receiving side runs.

The above-mentioned calculation formulae enable the camera adapter 101 to be synchronized with time generated by a time server serving as a synchronization master. While the time synchronization method in the present flow has been described with two steps (two types of packets, i.e., a Sync packet and a FollowUp packet, being used) taken as an example, one step (a FollowUp packet not being transmitted) can be employed. In that case, the Sync set time (T1) of the time server 102a is appended to a Sync packet. Moreover, the staying times (Tr1a, Tr1b, . . . ) of the Sync packet which the camera adapter 101 calculates are added to the Sync packet. Then, the timing at which to perform calculation of time synchronization is after the Sync packet is transferred.

As described above, according to the first exemplary embodiment, a synchronization slave terminal (camera adapter 101a) which performs relay of a synchronous packet stores time information about a master terminal (for example, the time server 102a) which is in synchronization with the synchronization slave terminal, and, when having detected the disappearance of the master terminal which is in synchronization with the synchronization slave terminal, with respect to a packet which a terminal serving as a new synchronization master (for example, the time server 102b) transmits, the synchronization slave terminal changes time information (header information) retained in the packet with the stored time information.

In a state in which a synchronization master has disappeared, synchronization slave terminals 101b to 101z which receive a packet having the changed time information no longer detect the disappearance of the synchronization master. As a result, the synchronization slave terminals immediately become able to be synchronized in time with a new synchronization master (time server 102b), and thus become able to prevent a time error from expanding. In conventional art, if time information is not obtained from a synchronization master within a predetermined time, since a synchronization slave terminal operates with a free-running clock signal until time synchronization with a new synchronization master is established, a synchronization slave located on the more downstream side in a synchronous image capturing system becomes larger in synchronization error from the synchronization master. In the case of the first exemplary embodiment, such an increase in synchronization error does not occur.

Furthermore, while, in the above-described first exemplary embodiment, the time servers 102a and 102b can become a time synchronization master, the number of time servers which can become a synchronization master is not limited to two. Moreover, a terminal which can become a time synchronization master can be a terminal (device) other than time servers.

In the above-described first exemplary embodiment, a method of changing ClockIdentity and PortId to cause a synchronization slave terminal located on the downstream side not to recognize switching of a synchronization master has been described.

In a second exemplary embodiment, a method of also changing SequenceId to improve interconnectivity with a commercially available product is further described.

The configurations of the synchronous image capturing system 100, the camera adapter 101, and the time server 102 are the same as those in the first exemplary embodiment and are, therefore, omitted from description. Moreover, the synchronous image capturing sequence of the synchronous image capturing system 100 and the time synchronization flow of the time server 102 are also the same as those in the first exemplary embodiment and are, therefore, omitted from description.

Additionally, the flowchart for reception of a synchronous packet of the camera adapter 101, the flow of BMCA, and the time synchronization sequence between the time server 102 and the camera adapter 101 are also the same as those in the first exemplary embodiment and are, therefore, omitted from description.

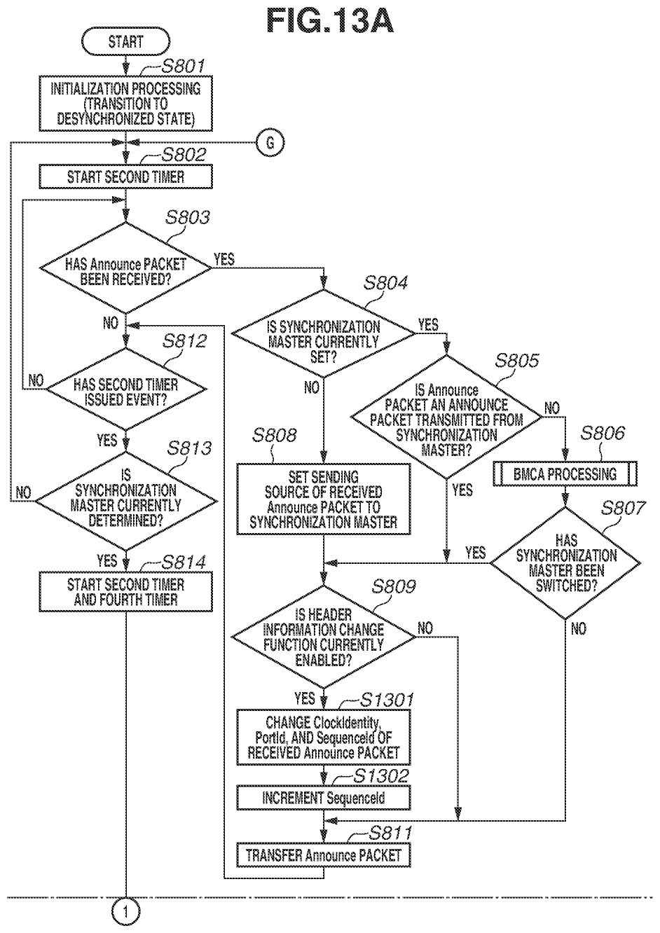

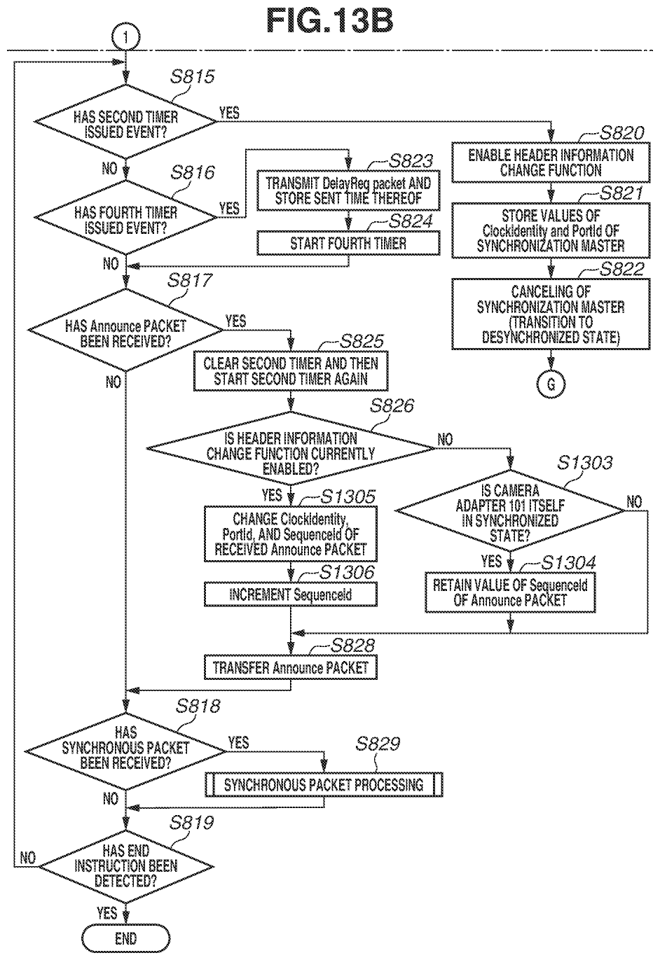

A time synchronization processing flow of the camera adapter 101 is described with reference to FIGS. 13A and 13B. Furthermore, steps for performing processing operations similar to those in the first exemplary embodiment (FIGS. 8A and 8B) are assigned the respective same reference characters as those in the first exemplary embodiment, and the description thereof is omitted here.

In the second exemplary embodiment, the camera adapter 101 performs steps S1301 and S1302 instead of step S810 illustrated in FIG. 8A. After step S809, the camera adapter 101 advances the processing to step S1301.

In step S1301, the camera adapter 101 changes ClockIdentity, PortId, and SequenceId of the received Announce packet, and then advances the processing to step S1302. SequenceId is described below.

In step S1302, the camera adapter 101 increments SequenceId, and then advances the processing to step S811.

In the second exemplary embodiment, in a case where the result of determination in step S826 is YES, the camera adapter 101 performs steps S1305 and S1306 instead of step S827 illustrated in FIG. 8B. After step S1306, the camera adapter 101 advances the processing to step S828. Moreover, in the second exemplary embodiment, in a case where the result of determination in step S826 is NO, without advancing the processing directly to step S828, the camera adapter 101 performs steps S1303 and S1304, and then advances the processing to step S828.

In step S1303, the camera adapter 101 determines whether the camera adapter 101 itself is in the synchronized state. If it is determined that the camera adapter 101 itself is in the synchronized state (YES in step S1303), the camera adapter 101 advances the processing to step S1304, and, if not so (NO in step S1303), the camera adapter 101 advances the processing to step S828.

In step S1304, the camera adapter 101 retains the value of SequenceId of the Announce packet, and then advances the processing to step S828.

In step S1305, the camera adapter 101 changes ClockIdentity, PortId, and SequenceId of the received Announce packet, and then advances the processing to step S1306.

In step S1306, the camera adapter 101 increments SequenceId, and then advances the processing to step S828.

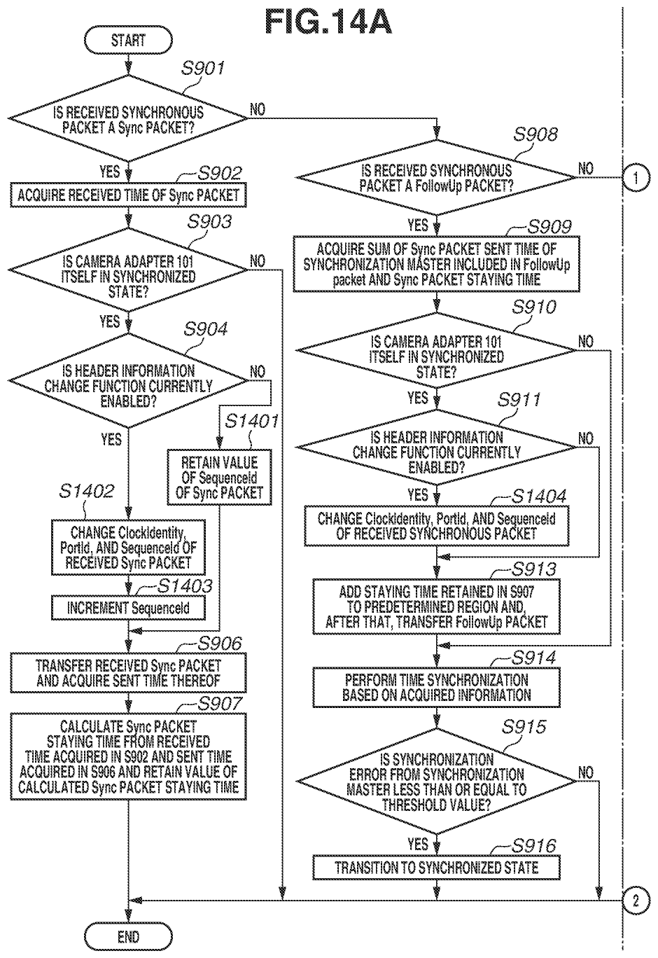

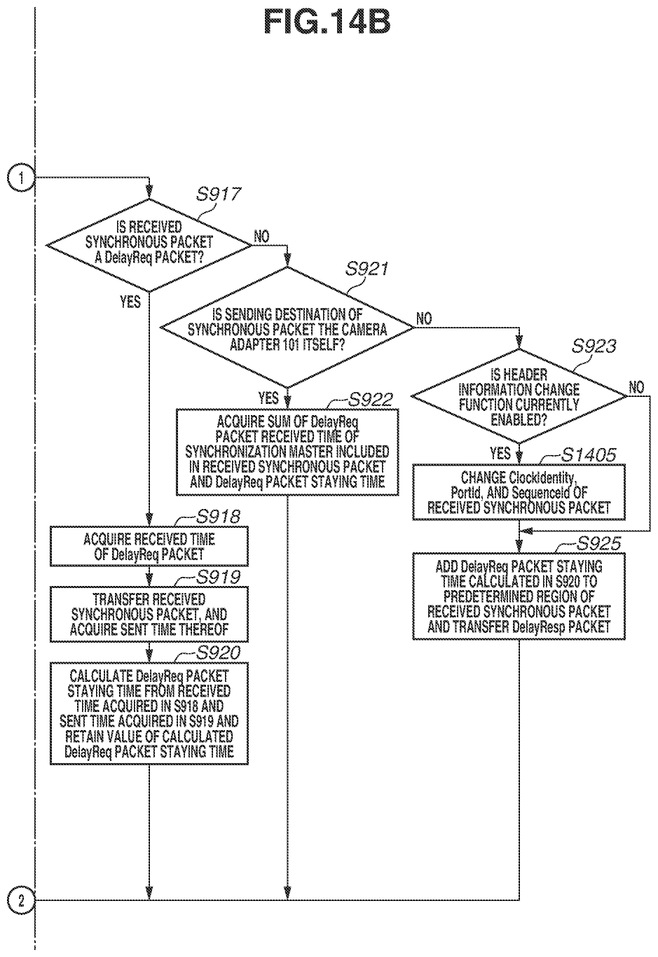

Next, a flow for synchronous packet processing in the second exemplary embodiment is described with reference to FIGS. 14A and 14B.

Furthermore, steps for performing processing operations similar to those in the first exemplary embodiment (FIGS. 9A and 9B) are assigned the respective same reference characters as those in the first exemplary embodiment, and the description thereof is omitted here.

In the second exemplary embodiment, in a case where the result of determination in step S904 is YES, the camera adapter 101 performs steps S1402 and S1403 instead of step S905 illustrated in FIG. 9A. After step S1403, the the camera adapter 101 advances the processing to step S906. Moreover, in the second exemplary embodiment, in a case where the result of determination in step S904 is NO, without advancing the processing directly to step S906, the camera adapter 101 performs step S1401, and then advances the processing to step S906.

In step S1401, the camera adapter 101 retains the value of SequenceId of the Sync packet, and then advances the processing to step S906. In step S1402, the camera adapter 101 changes ClockIdentity, PortId, and SequenceId of the received Sync packet, and then advances the processing to step S1403.

In step S1403, the camera adapter 101 increments SequenceId, and then advances the processing to step S906.

In the second exemplary embodiment, the camera adapter 101 performs step S1404 instead of step S912 illustrated in FIG. 9A. After step S1404, the camera adapter 101 advances the processing to step S913.

In step S1404, the camera adapter 101 changes ClockIdentity, PortId, and SequenceId (header information) of the received FollowUp packet, and then advances the processing to step S913.

In the second exemplary embodiment, in a case where the result of determination in step S923 is YES, the camera adapter 101 performs step S1405 instead of step S924 illustrated in FIG. 9B. After step S1405, the camera adapter 101 advances the processing to step S925.

In step S1405, the camera adapter 101 changes ClockIdentity, PortId, and SequenceId (header information) of the received DelayResp packet, and then advances the processing to step S925.

Usually, SequenceId is incremented independently for each packet. Accordingly, the camera adapter 101 preliminarily stores SequenceId for each packet, and, as soon as the header information change function is enabled, the camera adapter 101 uses the preliminarily stored SequenceId to change header information. The Sync packet and the FollowUp packet use the same SequenceId value to check a correspondence relationship between each other. Accordingly, the camera adapter 101 changes SequenceId for use in step S1404 based on the information stored in step S1401. Since, if, in step S1404, the camera adapter 101 directly applies the value of SequenceId incremented in step S1403, the correspondence relationship is broken, when applying SequenceId in step S1404, the camera adapter 101 performs processing for once decrementing the value of SequenceId and, after the completion of transfer, recovering the value of SequenceId.

The present disclosure can be implemented by taking exemplary embodiments in the form of, for example, a system, an apparatus, a method, a program, or a recording medium (storage medium). Specifically, the present disclosure can be applied to a system configured with a plurality of devices (for example, a host computer, an interface device, and a web application) or can be applied to an apparatus configured with only one device.

Moreover, the present disclosure can also be implemented by supplying a program (computer program) for implementing one or more functions of the above-described exemplary embodiments to a system or apparatus via a network or a recording medium (storage medium). One or more processors in a computer of the system or apparatus read out and execute the program. In this case, the program (program code) itself read out from the recording medium implements one or more functions of the exemplary embodiments. Moreover, a recording medium on which the program has been recorded can constitute the present disclosure.

Moreover, not only one or more functions of the exemplary embodiments are implemented by the computer executing the read-out program, but also one or more functions of the exemplary embodiments can be implemented by, for example, an operating system (OS), which is running on the computer, performing a part or the whole of actual processing based on an instruction of the program.

Additionally, after the program read out from the recording medium is written into a memory included in a function expansion card inserted into the computer or a function expansion unit connected to the computer, one or more functions of the exemplary embodiments can be implemented by, for example, a CPU included in the function expansion card or function expansion unit performing a part or the whole of actual processing based on an instruction of the program.

In a case where the present disclosure is applied to the above-mentioned recording medium, programs corresponding to the above-described flowcharts are stored in the recording medium.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-137745 filed Aug. 31, 2022, which is hereby incorporated by reference herein in its entirety.

What is claimed is:

1. A communication apparatus comprising:
a reception unit configured to receive a predetermined packet from a time synchronization master terminal;
a change unit configured to, in a case where the reception unit is not able to receive the predetermined packet within a predetermined time, change header information included in a predetermined packet transmitted by and received from a terminal newly becoming a time synchronization master to header information included in the predetermined packet received from the initial time synchronization master terminal; and
a transmission unit configured to transmit the predetermined packet including the header information changed by the change unit to a second communication apparatus.

2. The communication apparatus according to claim 1, wherein the header information which is changed by the change unit includes ClockIdentity and PortId.

3. The communication apparatus according to claim 2, wherein the header information which is changed by the change unit further includes SequenceId.

4. The communication apparatus according to claim 1, wherein the predetermined packet is an Announce packet defined in IEEE 1588-2008 standard.

5. The communication apparatus according to claim 1, wherein the predetermined packet is a Sync packet defined in IEEE 1588-2008 standard.

6. The communication apparatus according to claim 1, wherein the predetermined packet is a FollowUp packet defined in IEEE 1588-2008 standard.

7. The communication apparatus according to claim 1, wherein the predetermined packet is a DelayResp packet defined in IEEE 1588-2008 standard.

8. The communication apparatus according to claim 1, wherein the predetermined time is shorter than a time which is set to the second communication apparatus and within which the second communication has to receive the predetermined packet.

9. The communication apparatus according to claim 8, wherein the terminal newly becoming a time synchronization master is set in such a way as to receive the predetermined packet within the predetermined time.

10. The communication apparatus according to claim 9, wherein the time which is set to the second communication apparatus and within which the second communication has to receive the predetermined packet is previously determined based on at least the predetermined time and a transmission interval of an Announce packet defined in IEEE 1588-2008 standard which the initial time synchronization master terminal transmits.

11. The communication apparatus according to claim 1, wherein the communication apparatus and the second communication apparatus are daisy-chained time synchronization slave terminals.

12. A time synchronization system configured with a plurality of terminals each capable of becoming a time synchronization master and a plurality of time synchronization slave terminals,
wherein one of the plurality of time synchronization slave terminals is the communication apparatus according to claim 1,
wherein another of the plurality of time synchronization slave terminals is the second communication apparatus,
wherein one of the plurality of terminals each capable of becoming a time synchronization master is the initial time synchronization master terminal, and
wherein another of the plurality of terminals each capable of becoming a time synchronization master is the terminal newly becoming a time synchronization master.

13. A control method for a communication apparatus, the control method comprising:
causing the communication apparatus to receive a predetermined packet from a time synchronization master terminal;
causing the communication apparatus to, in a case where the communication apparatus is not able to receive the predetermined packet within a predetermined time, change header information included in a predetermined packet transmitted by and received from a terminal newly becoming a time synchronization master to header information included in the predetermined packet received from the initial time synchronization master terminal; and
causing the communication apparatus to transmit the predetermined packet including the changed header information to a second communication apparatus.

14. A non-transitory computer-readable storage medium storing computer-executable instructions that, when executed by a computer, cause the computer to perform a control method for a communication apparatus, the control method comprising:
causing the communication apparatus to receive a predetermined packet from a time synchronization master terminal;
causing the communication apparatus to, in a case where the communication apparatus is not able to receive the predetermined packet within a predetermined time, change header information included in a predetermined packet transmitted by and received from a terminal newly becoming a time synchronization master to header information included in the predetermined packet received from the initial time synchronization master terminal; and
causing the communication apparatus to transmit the predetermined packet including the changed header information to a second communication apparatus.
